(19) United States
(12) Patent Application Publication
(10) Pub. No.: US 2015/0025778 A1
(43) Pub. Date: Jan. 22, 2015

(54) GAS-SENSOR-CONTROL DEVICE AND CONTROL DEVICE OF INTERNAL COMBUSTION ENGINE

(71) Applicant: DENSO CORPORATION, Kariya-city, Aichi-pref. (JP)

(72) Inventors: Mikiyasu Matsuoka, Obu-city (JP); Shingo Nakata, Kariya-city (JP)

(21) Appl. No.: 14/376,243

(22) PCT Filed: Jan. 22, 2013
(86) PCT No.: PCT/JP2013/000285

§ 371 Date: Aug. 1, 2014

(30) Foreign Application Priority Data
Feb. 3, 2012 (JP) 2012-22262
Feb. 3, 2012 (JP) 2012-22472
Oct. 2, 2012 (JP) 2012-220691

(51) Int. Cl. F02D 41/30

(52) U.S. Cl. CPC F02D 41/30
USPC 701/104; 701/102

(57) ABSTRACT

A constant current is made to flow between sensor electrodes by a constant current circuit provided in the outside of the oxygen sensor, whereby the output characteristics of an oxygen sensor can be changed. Further, when a specified current-switching-permission condition is met, a value of current flowing between the sensor electrodes is switched and a direct current resistance value (internal resistance value) of the oxygen sensor is computed from a difference in the output of the oxygen sensor and a difference in the value of the current between before and after switching the value of the current flowing between the sensor electrodes. Then, at the time of a constant current supply in which the constant current is made to flow between the sensor electrodes, in other words, when the output characteristics of the oxygen sensor are changed, an amount of output-voltage-variation is found from a constant current value and a direct resistance value at that time. Then, the output of the oxygen sensor is corrected by the use of the amount of output-voltage-variation. In this way, an air-fuel ratio control based on the output of the oxygen sensor can be performed with high accuracy.

### CROSS REFERENCE TO RELATED APPLICATION

This application is based on Japanese Patent Applications No. 2012-22262 filed on Feb. 3, 2012, No. 2012-22472 filed on Feb. 3, 2012, and No. 2012-220691 filed on Oct. 2, 2012, the disclosures of which are incorporated herein by reference.

### TECHNICAL FIELD

The present disclosure is an invention relating to a gas-sensor-control device having a gas sensor for sensing a concentration of a specified component contained in gas to be sensed and a control device of an internal combustion engine.

### BACKGROUND ART

In recent years, in a vehicle mounted with an engine (internal combustion engine), there is proposed a vehicle in which: a catalyst for cleaning an emission gas is fixed in an exhaust pipe, and an emission gas sensor (air-fuel ratio sensor or an oxygen sensor) for sensing an air-fuel ratio of the emission gas or sensing whether an air-fuel ratio of the emission gas is rich or lean is fixed upstream of the catalyst or both upstream and downstream of the catalyst. The air-fuel ratio is fed back and controlled on the basis of an output of the emission gas sensor, whereby an emission gas cleaning rate of the catalyst is increased.

In the emission gas sensor such as the oxygen sensor, when the air-fuel ratio of the emission gas is changed from a rich state to a lean state or vice versa, the output of the gas sensor is delayed with respect to a change in an actual air-fuel ratio. Hence, it is necessary for improving a sensing responsiveness.

For example, as described in Patent Literature 1 (JP-H08-20414 A), there is proposed the following technique: that is, a gas sensor such as an oxygen sensor has at least one auxiliary electrochemical cell built therein and the auxiliary electrochemical cell is connected to one electrode of the gas sensor; and an impressed current is applied to the auxiliary electrochemical cell to thereby perform an ion pumping, whereby the output characteristics of the gas sensor can be changed according to the impressed current and the sensing responsiveness of the gas sensor can be improved.

As described in Patent Literature 2 (JP-S59-215935 A), Patent Literature 3 (JP-S59-226251 A), and Patent Literature 4 (JP-S60-98141 A), a gas sensor (oxygen sensor) has a sensor element in which a solid electrolyte layer is arranged between a reference electrode and a measuring electrode. A current supply portion generates an electric current flow from the reference electrode to the measuring electrode so as to shift the output characteristic curve of the gas sensor in a lean direction.

In a system for generating an electric current flow between the electrodes of the gas sensor so as to change the output characteristics of the gas sensor, when the electric current is supplied between the electrodes, a voltage variation (voltage drop or voltage rise) is caused in the output of the gas sensor due to an internal resistance of the gas sensor. Hence, if the effect of an output-voltage-variation caused by the internal resistance is not taken into account, there is a possibility that control based on the output of the gas sensor cannot be performed with high accuracy. For example, in a system for performing an air-fuel ratio feedback control on the basis of the output of the gas sensor, there is a possibility that the control accuracy of an air-fuel ratio is deteriorated to thereby cause a deterioration of an exhaust emission.

In the Patent Literature 2 described above, a voltage “Vi” proportional to a current “Is” flowing between the electrodes of a gas sensor is multiplied by a constant “K” to thereby obtain an amount of output-voltage-variation (K×Vi) caused by an internal resistance, and an output of the gas sensor is corrected by the use of the amount of output-voltage-variation (K×Vi).

In the Patent Literature 3 described above, a voltage “Vi” proportional to a current “Is” flowing between the electrodes of a gas sensor is multiplied by a constant “K” to thereby obtain an amount of output-voltage-variation (K×Vi) caused by an internal resistance, and a comparison reference value of an air-fuel ratio (value corresponding to a target air-fuel ratio) is corrected by the use of the amount of output-voltage-variation (K×Vi).

In the Patent Literature 4 described above, a current “Is” is supplied between the electrodes of a gas sensor and a square wave current “If” (alternating current) of a specified frequency is supplied between the electrodes of the gas sensor and a specified frequency component is extracted from the output of the gas sensor by a band-pass filter. Then, an amount of output-voltage-variation Vc (=G×Vi×ΔV) caused by an internal resistance is found on the basis of an amplitude ΔV (value corresponding to an internal resistance) of the specified frequency component and a voltage “Vi” proportional to the current “Is”. Then, a comparison reference value (value corresponding to a target air-fuel ratio) of an air-fuel ratio control is corrected by the use of the amount of output-voltage-variation “Vc”.

In a technique described in the Patent Literature 1, the gas sensor needs to have the auxiliary electrochemical cell built therein and hence needs to have its sensor structure enlarged as compared with an ordinary gas sensor not having the auxiliary electrochemical cell built therein. Hence, when the technique described in the Patent Literature 1 is put into practical use, the design of a gas sensor needs to be changed and hence the manufacturing cost of the gas sensor is increased.

The internal resistance of the gas sensor is changed by the individual difference (variations in manufacturing), the secular change and the temperature of the gas sensor, so that an amount of output-voltage-variation caused by the internal resistance of the gas sensor is also changed. However, in the techniques described in the Patent Literatures 2, 3, a change in the internal resistance caused by the individual difference, the secular change, and the temperature of the gas sensor is not taken into account, but the voltage “Vi” proportional to the current “Is” flowing between the electrodes of the gas sensor is simply multiplied by the constant “K” to thereby obtain the amount of output-voltage-variation caused by the internal resistance of the gas sensor. Hence, the amount of output-voltage-variation caused by the internal resistance of the gas sensor cannot be found with high accuracy and hence there is a possibility that the control (for example, air-fuel ratio control) based on the output of the gas sensor cannot be performed with high accuracy.

In the technique described in the Patent Literature 4, the square wave current “If” (alternating current) of the specified frequency is supplied between the electrodes of the gas sensor and the amplitude ΔV of the specified frequency component, which is extracted from the output of the gas sensor by the band-pass filter, is used as the information of the internal resistance of the gas sensor, whereby the amount of output-voltage-variation caused due to the internal resistance of the gas sensor is obtained. At that time, however, the information of the internal resistance of the gas sensor is obtained by supplying the alternating current and hence the output-voltage-variation suffers the effect of not only the internal resistance (direct current resistance) of the gas sensor but also the electrostatic capacity of the gas sensor. For this reason, there is a possibility that the amount of output-voltage-variation caused due to the internal resistance of the gas sensor cannot be found with high accuracy and that the control (for example, air-fuel ratio control) based on the output of the gas sensor cannot be performed with high accuracy. In addition, the technique described in the Patent Literature 4 needs a circuit for supplying an alternating current and a band-pass filter and hence has also a fault of making a circuit configuration complex.

### PRIOR ART LITERATURES

### Patent Literature

[Patent Literature 1] JP-H08-20414 A
[Patent Literature 1] JP-S59-215935 A
[Patent Literature 1] JP-S59-226251 A
[Patent Literature 1] JP-S60-98141 A

### SUMMARY OF INVENTION

A subject to be solved by the present disclosure is to make it possible to change the output characteristics of a gas sensor without causing a drastic design change and a large increase in cost of the gas sensor and to prevent a malfunction caused by an output-voltage-variation due to the internal resistance of the gas sensor when current is supplied to the gas sensor.

According to one aspect of the present disclosure, a gas-sensor-control device has a gas sensor including a sensor element for sensing a concentration of a specified component contained in a gas. The sensor element has a solid electrolyte material arranged between a pair of sensor electrodes. The gas-sensor-control device includes: a constant current supply portion making a constant current flow between the sensor electrodes so as to change an output characteristic of the gas sensor; and an output-voltage-variation information computing portion computing an amount of output-voltage-variation of the gas sensor or an information correlating to the amount of output-voltage-variation (which is hereinafter generally referred to as “output-voltage-variation information”) at a time of a constant current supply in which the constant current flows between the sensor electrodes based on outputs of the gas sensor before and after switching a value of a current flowing between the sensor electrodes.

In this configuration, the output characteristics of the gas sensor can be changed by making the constant current flow between the sensor electrodes by the constant current supply portion. In this case, the gas sensor does not need to have the auxiliary electrochemical cell or the like built therein, so that the output characteristics of the gas sensor can be changed without causing a drastic design change and a large increase in cost of the gas sensor.

The output-voltage-variation information (an amount of output-voltage-variation caused by the internal resistance or information correlated to the amount of output-voltage-variation) of the gas sensor at the time of the constant current supply can be computed by the output-voltage-variation information computing portion on the basis of the outputs of the gas sensor before and after switching the value of the current flowing between the sensor electrodes. Hence, the control based on the output of the gas sensor can be performed in consideration of the output-voltage-variation information, which makes it possible to prevent a malfunction caused by the output-voltage-variation due to the internal resistance of the gas sensor at the time of supplying the constant current.

Further, when the value of the current flowing between the sensor electrodes is switched, the output-voltage-variation information is computed on the basis of the outputs of the gas sensor before and after switching the value of the current flowing between the sensor electrodes. Hence, even if the internal resistance of the gas sensor is changed by the individual difference (variations in manufacturing), the secular change and the temperature of the gas sensor, and the amount of output-voltage-variation caused due to the internal resistance of the gas sensor is changed, the output-voltage-variation information corresponding to the internal resistance of the gas sensor can be obtained with high accuracy.

The output-voltage-variation information is computed not by supplying an alternating current but on the basis of the outputs of the gas sensor before and after switching the current value of the constant current (direct current) flowing between the sensor electrodes. Hence, the output-voltage-variation information corresponding to the internal resistance of the gas sensor can be obtained with high accuracy without suffering the effect of the electrostatic capacity of the gas sensor. In addition, the gas-sensor-control device does not need to have a circuit for supplying an alternating current and a band-pass filter. Hence, the gas-sensor-control device has a circuit configuration simplified.

In this case, it is recommended that the gas-sensor-control device includes a determination portion determining whether specified current-switching-permission condition is met. When it is determined that the specified current-switching-permission condition is met, the computation of the output-voltage-variation information is performed by switching the value of the current flowing between the sensor electrodes. In this way, when the specified current-switching-permission condition is met and a state suitable for computing the output-voltage-variation information (for example, a state in which the output of the gas sensor becomes stable) is brought about, the computation of the output-voltage-variation information can be performed by switching the value of the current flowing between the sensor electrodes and hence the accuracy of the computation of the output-voltage-variation information can be improved.

The present disclosure may be applied to a system having a sensor for sensing whether an air-fuel ratio of an emission gas of an internal combustion engine is rich or lean.

In this case, it may be determined that the current-switching-permission condition is met when the output of the gas sensor is stable on rich or lean. In this way, when the output of the gas sensor is brought into the stable state on rich or lean, the computation of the output-voltage-variation information can be performed by switching the value of the current flowing between the sensor electrodes.

Specifically, it may be determined that the current-switching-permission condition is met during a fuel cutting period in which the fuel injection of the internal combustion engine is stopped. A lean gas flows in the exhaust gas pipe during the fuel cutting period to thereby bring the interior of the exhaust gas pipe into a lean state. Hence, when the output of the gas sensor is brought into the stable state on lean during the fuel cutting period, it is determined that the current-switching-permission condition is met during the fuel cutting period, so that the computation of the output-voltage-variation information can be performed by switching the value of the current flowing between the sensor electrodes.

Alternatively, it may be determined that the current-switching-permission condition is met after the internal combustion engine is stopped. After the internal combustion engine is stopped, the interior of the exhaust pipe is brought into a state (lean state) nearly equal to the atmosphere. Hence, when the output of the gas sensor is brought into the stable state on lean after the internal combustion engine is stopped so that it is determined that the current-switching-permission condition is met, the computation of the output-voltage-variation information can be performed by switching the value of the current flowing between the sensor electrodes.

Further, it may be determined that the current-switching-permission condition is met during a fuel-quantity-increase control for increasing a fuel injection quantity of the internal combustion engine. During the fuel-quantity-increase control, a rich gas flows in the exhaust pipe to thereby bring the interior of the exhaust pipe into a rich state. Hence, when the output of the gas sensor is brought into the stable state on rich during the fuel-quantity-increase control and it is determined that the current-switching-permission condition is met, the computation of the output-voltage-variation information can be performed by switching the value of the current flowing between the sensor electrodes.

When the value of the current flowing between the sensor electrodes is “0”, an error included in the output of the gas sensor becomes small, so that at the time of switching the value of current flowing between the sensor electrodes, one of the values of the current before and after switching the value of the current may be set to “0”. In this way, the accuracy of the computation of the output-voltage-variation information based on the output of the gas sensor can be further improved.

When an abnormality (for example, a failure or the like) is caused in the constant current supply portion for making the constant current flow between the sensor electrodes, the output characteristics of the gas sensor cannot be properly changed and hence the control (for example, air-fuel ratio feedback control) based on the output of the gas sensor cannot be property performed. Hence, when an abnormality is caused in the constant current supply portion, the abnormality needs to be quickly detected.

Hence, the gas-sensor-control device may include an abnormality diagnosis portion for performing an abnormality diagnosis in which it is determined whether an abnormality is caused in the constant current supply portion on the basis of the output-voltage-variation information. When an abnormality (for example, a failure or the like) is caused in the constant current supply portion, the behavior of the output of the gas sensor of when the value of the current flowing between the sensor electrodes is switched becomes different from the behavior of the output of the gas sensor of when the constant current supply portion is normal. Hence, it can be determined with high accuracy whether an abnormality is caused in the constant current supply portion by performing the abnormality diagnosis. In the abnormality diagnosis, it is determined whether an abnormality is caused in the constant current supply portion by the use of the output-voltage-variation information calculated on the basis of the outputs of the gas sensor before and after switching the value of the current flowing between the sensor electrodes. Hence, when an abnormality is caused in the constant current supply portion, the abnormality can be quickly detected.

The control device of an internal combustion engine has the gas-sensor-control device described above and a control portion for performing a control of the internal combustion engine on the basis of an output of the gas sensor. The control device of the internal combustion engine may include a sensor-output-correction portion for correcting the output of the gas sensor on the basis of the output-voltage-variation information at the time of the constant current supply. The control of the Internal combustion engine may be performed based on the output of the gas sensor corrected by the sensor-output-correction portion. In this way, at the time of the constant current supply, the control device of the internal combustion engine can perform the control based on the output of the gas sensor with high accuracy without suffering the effect of the output-voltage-variation caused due to the internal resistance of the gas sensor.

In this case, a direct current resistance value of the gas sensor may be computed as the output-voltage-variation information. An amount of output-voltage-variation is obtained from the constant current value and the direct current resistance value at the time of the constant current supply. The output of the gas sensor is corrected by the use of the amount of output-voltage-variation. In this way, for example, even when the constant current value at the time of the constant current supply is changed according to the operating state or the like of the internal combustion engine, the amount of output-voltage-variation (an amount of output voltage drop or an amount of output voltage rise) can be obtained with high accuracy from the constant current value and the direct current resistance value at the time of the constant current supply. The output of the gas sensor can be corrected with high accuracy by the use of the amount of output-voltage-variation.

Further, the control device of the internal combustion engine may include a prohibition portion for prohibiting the sensor-output-correction portion from correcting the output of the gas sensor by when the abnormality diagnosis portion determines that an abnormality is caused in the constant current supply portion. In this way, it is possible to prevent the output of the gas sensor from being corrected on the basis of the output-voltage-variation information which is out of a normal range due to an abnormality caused in the constant current supply portion.

In a control device of an internal combustion engine having the gas-sensor-control device described above and the control portion for performing an air-fuel ratio control of the internal combustion engine on the basis of an output of the gas sensor, the control device of the internal combustion engine may include a target-value-correction portion for correcting a target value of the air-fuel ratio control on the basis of the output-voltage-variation information at the time of the constant current supply and may perform the air-fuel ratio control by the use of the target value corrected by the target-value-correction portion. In this way, at the time of the constant current supply, the control device of the internal combustion engine can perform the air-fuel ratio control based on the output of the gas sensor with high accuracy without suffering the effect of the output-voltage-variation caused due to the internal resistance of the gas sensor.

In this case, a direct current resistance value of the gas sensor may be computed as the output-voltage-variation information. An amount of output-voltage-variation is obtained from the constant current value and the direct current resistance value at the time of the constant current supply. The target value may be corrected by the use of the amount of output-voltage-variation. In this way, for example, even when the constant current value at the time of the constant current supply is changed according to the operating state or the like of the internal combustion engine, the amount of output-voltage-variation (an amount of output voltage drop or an amount of output voltage rise) can be obtained with high accuracy from the constant current value and the direct current resistance value at the time of the constant current supply. The target value of the air-fuel ratio control can be corrected with high accuracy by the use of the amount of output-voltage-variation.

Further, the control device of the internal combustion engine may include a prohibition portion for prohibiting the target value of the air-fuel ratio control from being corrected by the target-value-correction portion when the abnormality diagnosis portion determines that an abnormality is caused in the constant current supply portion. In this way, it is possible to prevent the control device of the internal combustion engine from correcting the target value of the air-fuel ratio control on the basis of the output-voltage-variation information which is out of a normal range due to the abnormality caused in the constant current supply portion.

### BRIEF DESCRIPTION OF DRAWINGS

FIG. 1 is a diagram to show a general configuration of an engine control system in an embodiment 1 of the present invention.

FIG. 2 is a section view to show a sectional construction of a sensor element.

FIG. 3 is an electromotive characteristic graph to show a relationship between an air-fuel ratio (excess air ratio λ) of an emission gas and an electromotive of a sensor element.

FIG. 4A is a schematic diagram to show a state of a gas component around a sensor element.

FIG. 4B is a schematic diagram to show a state of a gas component around a sensor element.

FIG. 5 is a time chart to illustrate a behavior of a sensor output.

FIG. 6A is a schematic diagram to show a state of a gas component around a sensor element.

FIG. 6B is a schematic diagram to show a state of a gas component around a sensor element.

FIG. 7 is an output characteristic graph of an oxygen sensor when a lean responsiveness and a rich responsiveness are improved.

FIG. 8 is a flow chart to show a processing flow of a sensor responsiveness control routine of the embodiment 1.

FIG. 9 is a flow chart to show a processing flow of a current switching permission determination routine of the embodiment 1.

FIG. 10 is a flow chart to show a processing flow of a direct current resistance value computation routine of the embodiment 1.

FIG. 11 is a flow chart to show a processing flow of a sensor output correction routine of the embodiment 1.

FIG. 12 is a flow chart to show a processing flow of a target voltage correction routine of an embodiment 2.

FIG. 13 is a time chart to illustrate an example of performing an abnormality-diagnosis-permission determination of an embodiment 3.

FIG. 14 is a time chart to illustrate an example of performing an abnormality diagnosis of the embodiment 3.

FIG. 15 is a flow chart to show a processing flow of an abnormality-diagnosis-permission determination routine of the embodiment 3.

FIG. 16 is a flow chart to show a processing flow of an abnormality diagnosis routine of the embodiment 3.

FIG. 17 is a flow chart to show a processing flow of an abnormality-diagnosis-permission determination routine of an embodiment 4.

FIG. 18 is a flow chart to show a processing flow of an abnormality-diagnosis-permission determination routine of an embodiment 5.

FIG. 19 is a time chart to illustrate an example of performing an abnormality diagnosis and a sensor output correction of an embodiment 6.

FIG. 20 is a flow chart to show a processing flow of performing an abnormality diagnosis and a sensor output correction routine of the embodiment 6.

### EMBODIMENTS FOR CARRYING OUT INVENTION

Hereinafter, some embodiments in which the present invention is embodied will be described.

### Embodiment 1

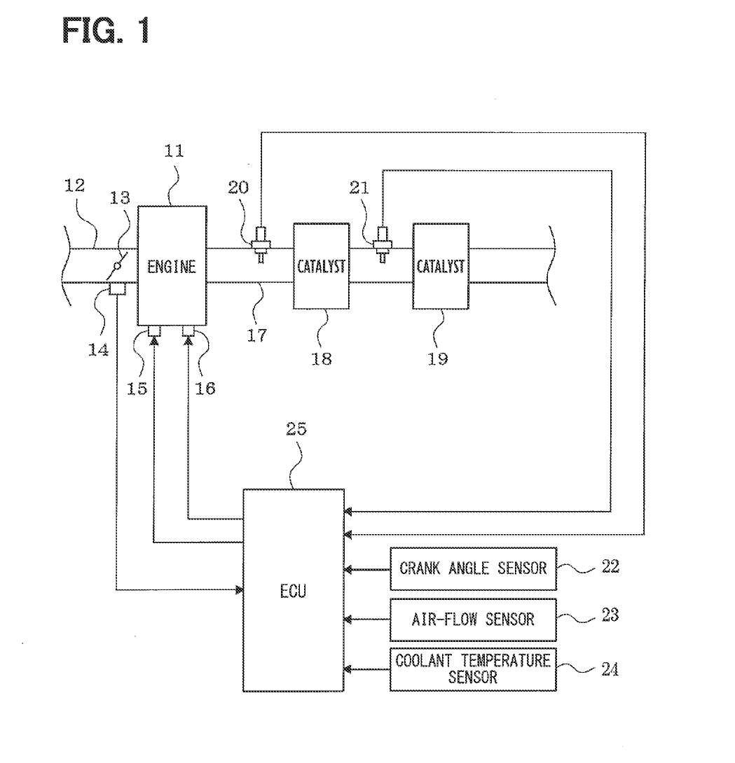

An embodiment 1 of the present disclosure will be described on the basis of FIG. 1 to FIG. 11.

A general configuration of an entire engine control system will be described on the basis of FIG. 1.

An intake pipe 12 of an engine 11 that is an internal combustion engine has a throttle valve 13, the opening of which is controlled by a motor or the like, and a throttle opening sensor 14, which senses an opening of the throttle valve 13 (throttle opening). Further, each of cylinders of the engine 11 is provided with a fuel injector 15 for performing a direct injection or an intake port injection, whereas a cylinder head of the engine 11 has an ignition plug 16 fixed on each of the cylinders. Air-fuel mixture in each of the cylinders is ignited by a spark discharge of each ignition plug 16.

On the other hand, an exhaust pipe 17 of the engine 11 is provided with an upstream-catalyst 18 and a downstream-catalyst 19, each of which is made of a three-way catalyst and deans CO, HC, and NOₓ in an emission gas. Further, on the upstream side of the upstream-catalyst 18, an air-fuel ratio sensor 20 for outputting an air-fuel ratio signal linear to an air-fuel ratio of the emission gas is fixed as an upstream-gas-sensor. On the other hand, on the downstream side of the upstream-catalyst 18 (between the upstream-catalyst 18 and the downstream-catalyst 19), an oxygen sensor (O₂ sensor) 21 the output voltage of which is reversed depending on whether the air-fuel ratio of the emission gas is rich or lean with respect to a stoichiometric air-fuel ratio is fixed as a downstream-gas-sensor.

The present system has various sensors such as a crank angle sensor 22 for outputting a pulse signal every time a crankshaft (not shown in the drawing) of the engine 11 is rotated by a specified crank angle, an air-flow sensor 23 for sensing an intake air volume of the engine 11, and a coolant temperature sensor 24 for sensing a coolant temperature of the engine 11. A crank angle and an engine rotation speed are sensed on the basis of an output signal of the crank angle sensor 22.

The outputs of these various sensors are inputted to an electronic control unit (hereinafter denoted by “ECU”) 25. The ECU 25 is mainly constructed of a microcomputer and executes various programs, which are stored in a built-in ROM (memory medium) and are used for controlling the engine, thereby functioning as a control portion for controlling a fuel injection quantity, an ignition timing, a throttle opening (intake air quantity), and the like according to an engine operating state.

At that time, when a specified air-fuel ratio F/B control performance condition is met, the ECU 25 performs a main F/B control for correcting an air-fuel ratio (fuel injection quantity) on the basis of an output (sensed air-fuel ratio) of the air-fuel ratio sensor 20 (upstream-gas-sensor) and a target air-fuel ratio on upstream of the upstream-catalyst 18 in such a way that an air-fuel ratio of the emission gas on upstream of the upstream-catalyst 18 becomes the target air-fuel ratio, and the ECU 25 corrects the target air-fuel ratio on upstream of the upstream-catalyst 18 on the basis of an output of the oxygen sensor (downstream-gas-sensor) 21 and a target voltage (target value). Alternatively, the ECU 25 performs a subordinate FIB control for correcting an FIB correction quantity or the fuel injection quantity of the main F/B control. It should be noted that “F/B” means “feedback” (ditto, hereinafter).

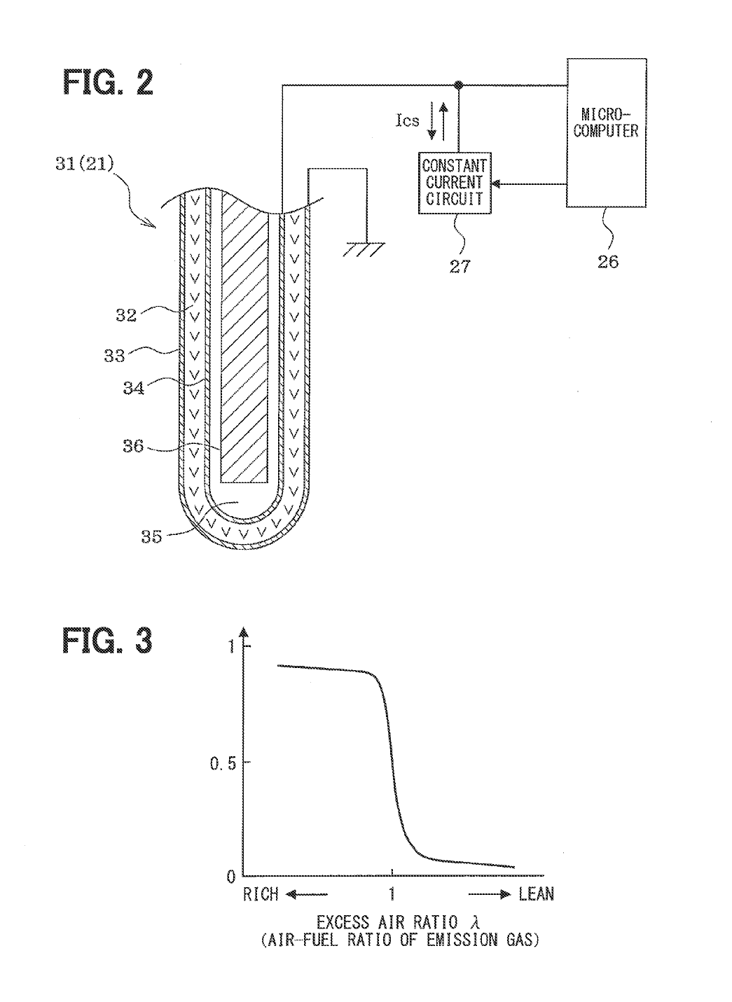

Next, the construction of the oxygen sensor 21 will be described on the basis of FIG. 2.

The oxygen sensor 21 has a sensor element 31 of a cup type structure. Specifically, the sensor element 31 is constructed in such a way that the whole of the element is housed in a housing or an element cover not shown in the drawing and is arranged in the exhaust pipe 17 of the engine 11.

In the sensor element 31, a solid electrolyte layer 32 (solid electrolyte material) is formed in the shape of a cup when viewed in a cross section and has an exhaust electrode layer 33 fixed on its outer surface and has an atmosphere electrode layer 34 fixed on its inner surface. The solid electrolyte layer 32 is formed of an oxygen ion conductive oxide sintered material in which CaO, MgO, Y₂O₃, or Yb₂O₃ is dissolved as a stabilizer in ZrO₂, HfO₂, ThO₂, or Bi₂O₃. Further, each of the electrode layers 33, 34 is formed of a noble metal such as platinum having an enhanced catalytic activity and has porous chemical plating or the like applied to its surface. These electrode layers 33, 34 form a pair of opposite electrodes (sensor electrodes). An inner space surrounded by the solid electrolyte layer 32 becomes an atmosphere chamber 35 and the atmosphere chamber 35 has a heater 36 housed therein. The heater 36 has a heating capacity sufficient for activating the sensor element 31 and the whole of the sensor element 31 is heated by the heating energy of the heater 36. An activation temperature of the oxygen sensor 21 is, for example, approximately 350 to 400° C. Here, the atmosphere chamber 35 has the atmosphere introduced thereinto, thereby having its interior held at a specified oxygen concentration.

In the sensor element 31, the outside (electrode layer 33) of the solid electrolyte layer 32 is in an exhaust atmosphere and the inside (electrode layer 34) of the solid electrolyte layer 32 is in the atmosphere, whereby an electromotive force is generated between the electrode layers 33, 34 according to a difference in the concentration of oxygen (a difference in oxygen partial pressure) between these atmospheres. In other words, in the sensor element 31, a different electromotive force is generated according to whether the air-fuel ratio is rich or lean. In this way, the oxygen sensor 21 outputs an electromotive force signal corresponding to the concentration of oxygen (that is, the air-fuel ratio) of the emission gas.

As shown in FIG. 3, the sensor element 31 generates a different electromotive force according to whether the air-fuel ratio is rich or lean with respect to a stoichiometric air-fuel ratio (excess air ratio λ=1) and has a characteristic such that the electromotive force is suddenly changed near the stoichiometric air-fuel ratio (excess air ratio λ=1). Specifically, when the air-fuel ratio is rich, the electromotive force generated by the sensor element 31 is approximately 0.9 V, whereas when the air-fuel ratio is lean, the electromotive force generated by the sensor element 31 is approximately 0 V.

As shown in FIG. 2, the sensor element 31 has the exhaust electrode layer 33 grounded to the earth and has the atmosphere electrode layer 34 connected to a microcomputer 26. When the sensor element 31 generates an electromotive force according to the air-fuel ratio (the concentration of oxygen) of the emission gas, a sensor sensing signal corresponding to the electromotive force is outputted to the microcomputer 26. In this regard, by offsetting the sensor sensing signal (voltage) to be inputted to the microcomputer 26 in a plus direction with respect to the electromotive force of the sensor element 31, even when a constant current is supplied (the output characteristic of the oxygen sensor 21 is changed, which will be describe later), the sensor sensing signal to be inputted to the microcomputer 26 may be varied within a range of a plus value.

The microcomputer 26 is built in, for example, the ECU 25 and calculates an air-fuel ratio on the basis of the sensor sensing signal. Here, the microcomputer 26 may calculate an engine rotation speed or an intake air quantity on the basis of the sensed results of the various sensors described above.

When the engine 11 is driven, an actual air-fuel ratio of the emission gas is successively varied and is repeatedly varied between a rich value and a lean value in some cases. At the time when the actual air-fuel ratio is varied in this way, when the sensing responsiveness of the oxygen sensor 21 is low, it is concerned that the low sensing responsiveness will cause a bad effect on the performance of the engine 11. For example, it is concerned that when the engine 11 is driven at a high load, the amount of NO in the emission gas will be increased more than expected.

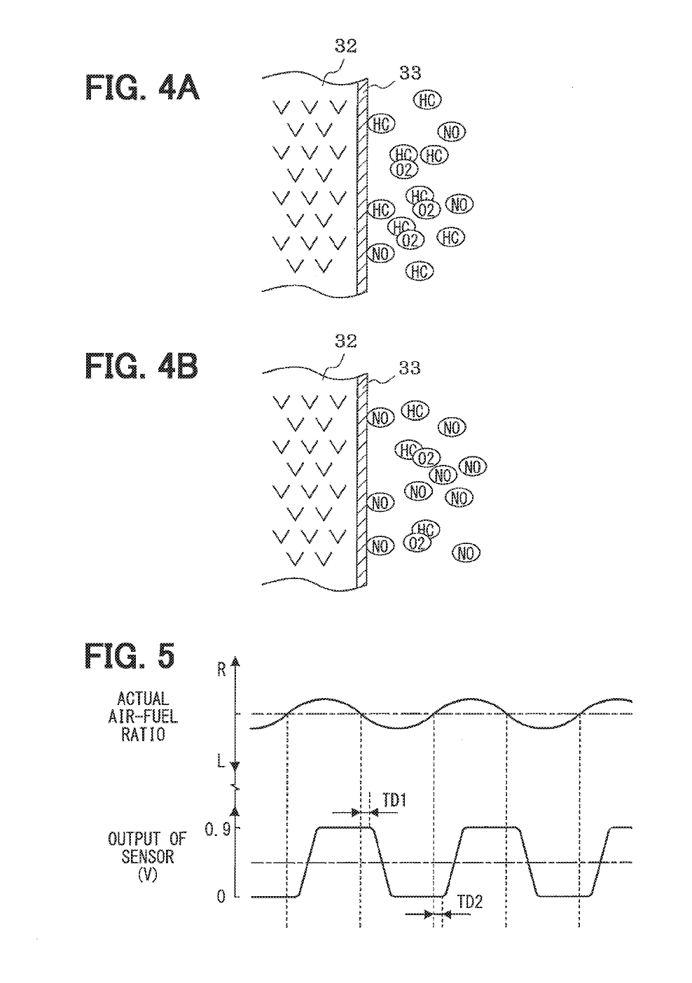

The sensing responsiveness of the oxygen sensor 21 when an actual air-fuel ratio is varied between a rich value and a lean value will be described. When the actual air-fuel ratio (actual air-fuel ratio on downstream of upstream-catalyst 18) is varied between the rich value and the lean value in the emission gas emitted from the engine 11, the component composition of the emission gas is changed. At this time, since the component of the emission gas just before the component composition being changed remains, a change in the output of the oxygen sensor 21 to the air-fuel ratio after the change (that is, the responsiveness of the output of the sensor) becomes slow. Specifically, when the actual air-fuel ratio is changed from the rich value to the lean value, as shown in FIG. 4A, just after the actual air-fuel ratio is changed to the lean value, HC or the like that is a rich component remains near the exhaust electrode layer 33 and hence the reaction of a lean component (NOₓ or the like) at the sensor electrode is prevented by the rich component. As a result, the oxygen sensor 21 is lowered in the responsiveness of a lean output. On the other hand, when the actual air-fuel ratio is changed from the lean value to the rich value, as shown in FIG. 4B, just after the actual air-fuel ratio is changed to the rich value, NOx or the like which is a lean component remains near the exhaust electrode layer 33 and hence the reaction of a rich component (HC or the like) at the sensor electrode is prevented by the lean component. As a result, the oxygen sensor 21 is lowered in the responsiveness of a rich output.

A change in the output of the oxygen sensor 21 will be described by the use of a time chart shown in FIG. 5. In FIG. 5, when an actual air-fuel ratio is changed between a rich value and a lean value, a sensor output (output of the oxygen sensor 21) is changed between a rich gas sensing value (0.9 V) and a lean gas sensing value (0 V) according to a change in the actual air-fuel ratio. However, in this case, the sensor output is changed with a delay relative to a change in the actual air-fuel ratio. In FIG. 5, when the actual air-fuel ratio is changed from the rich value to the lean value, the sensor output is changed with a delay of TD1 relative to the change in the actual air-fuel ratio, whereas when the actual air-fuel ratio is changed from the lean value to the rich value, the sensor output is changed with a delay of TD2 relative to the change in the actual air-fuel ratio.

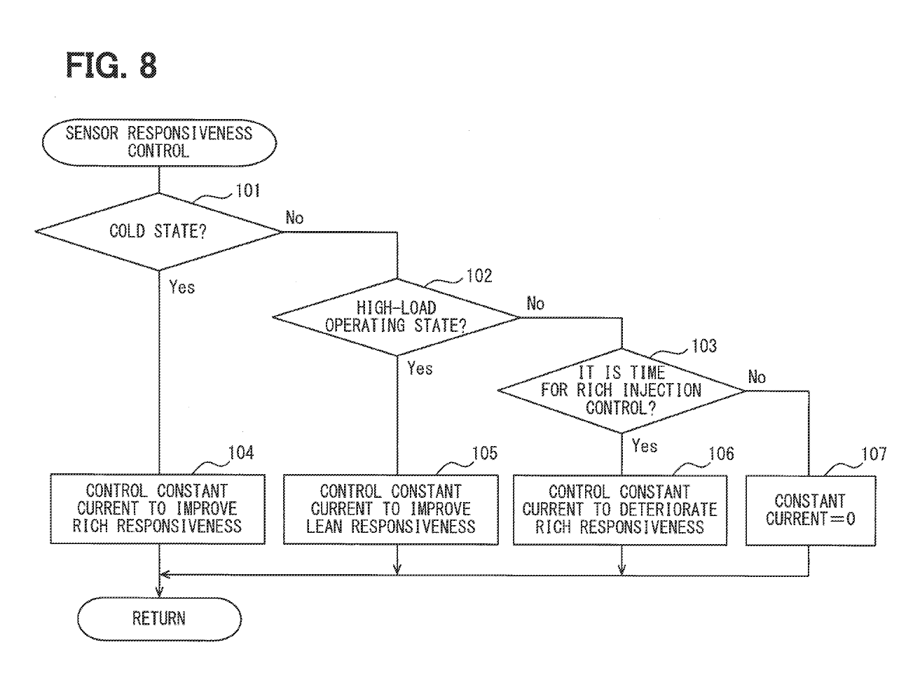

In the present embodiment 1, the ECU 25 (or the microcomputer 26) performs a routine shown in FIG. 8, which will be described later, thereby it is determined whether a change request relating to the sensing responsiveness of the oxygen sensor 21 is made for at least one of the sensing responsiveness of when the actual air-fuel ratio is changed to the lean value and the sensing responsiveness of when the actual air-fuel ratio is changed to the rich value. Then, if the ECU 25 determines that the change request is made, the ECU 25 performs a constant current control on the basis of the change request to thereby arbitrarily adjust the sensing responsiveness of the oxygen sensor 21. As for the control of the sensing responsiveness, the ECU 25 makes current flow in a specified direction between the sensor electrodes (the exhaust electrode layer 33 and the atmosphere electrode layer 34) to thereby variably control the sensing responsiveness of the oxygen sensor 21. Specifically, as shown in FIG. 2, a constant current circuit 27 as a constant current supply portion is connected to the atmosphere electrode layer 34 and the supply of a constant current “Ics” by the constant current circuit 27 is controlled by the microcomputer 26. In this case, the microcomputer 26 sets the direction and the quantity of the constant current flowing between the sensor electrodes and controls the constant current circuit 27 in such a way that the set constant current “Ics” flows.

In more detail, the constant current circuit 27 is a circuit that supplies the atmosphere electrode layer 34 with the constant current “Ics” in either of a forward direction or a reverse direction and that can variably adjust the flow rate of the constant current “Ics”. In other words, the microcomputer 26 variably controls the constant current “Ics” by a PWM control. In this case, in the constant current circuit 27, the constant current “Ics” is adjusted according to a duty signal outputted from the microcomputer 26 and the constant current “Ics” having its flow rate controlled is made to flow between the sensor electrodes (between the exhaust electrode layer 33 and the atmosphere electrode layer 34).

In the present embodiment, the constant current “Ics” flowing in the direction from the exhaust electrode layer 33 to the atmosphere electrode layer 34 is assumed to be a negative constant current (−“Ics”), whereas the constant current “Ics” flowing in the direction from the atmosphere electrode layer 34 to the exhaust electrode layer 33 is assumed to be a positive constant current (+“Ics”).

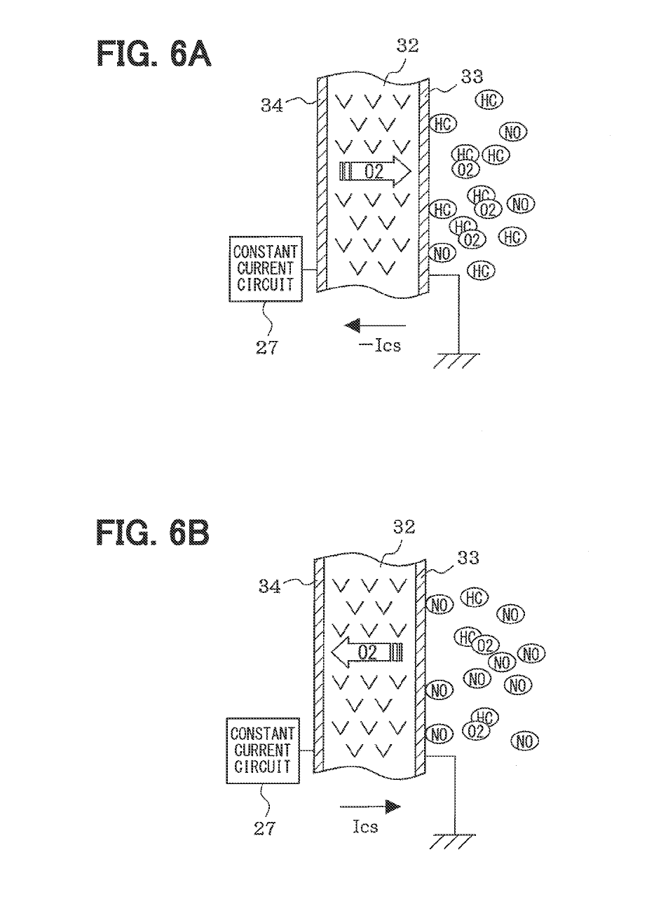

For example, when the sensing responsiveness (lean sensitivity) when the actual air-fuel ratio is changed from the rich value to the lean value is improved, as shown in FIG. 6A, the constant current “Ics” (negative constant current “Ics”) is made to flow in such a way that oxygen is supplied from the atmosphere electrode layer 34 to the exhaust electrode layer 33 through the solid electrolyte layer 32. In this case, the oxygen is supplied to the exhaust-side from the atmosphere-side, whereby an oxidation reaction of the rich component (HC) existing (remaining) around the exhaust electrode layer 33 is accelerated and hence the rich component can be quickly removed by the accelerated oxidation reaction. In this way, the lean component (NOₓ) can be easily reacted in the exhaust electrode layer 33, which results in improving the responsiveness of the lean output of the oxygen sensor 21.

On the other hand, when the sensing responsiveness (rich sensitivity) when the actual air-fuel ratio is changed from the lean value to the rich value is improved, as shown in FIG. 6B, the constant current “Ics” (positive constant current “Ics”) is made to flow in such a way that oxygen is supplied from the exhaust electrode layer 33 to the atmosphere electrode layer 34 through the solid electrolyte layer 32. In this case, the oxygen is supplied to the atmosphere-side from the exhaust-side, whereby the reduction reaction of the lean component (NOₓ) existing (remaining) around the exhaust electrode layer 33 is accelerated and hence the lean component can be quickly removed by the accelerated reduction reaction. In this way, the rich component (HC) can be easily reacted in the exhaust electrode layer 33, which results in improving the responsiveness of the rich output of the oxygen sensor 21.

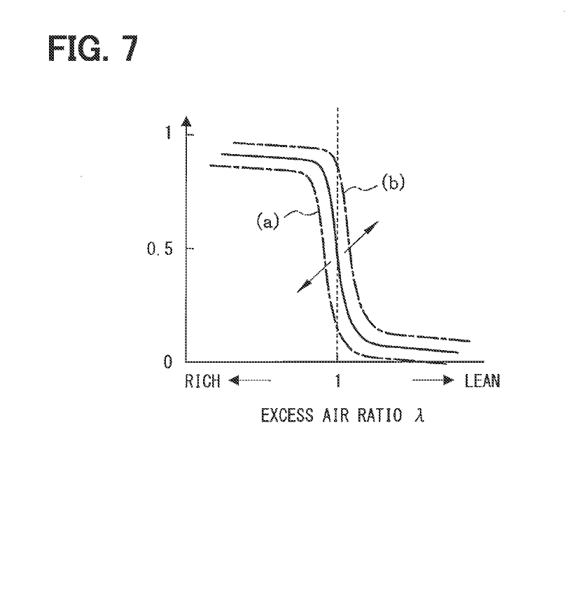

FIG. 7 is a graph to show the output characteristics (electromotive characteristics) of the oxygen sensor 21 when the sensing responsiveness (lean sensitivity) of when the actual air-fuel ratio is changed to the lean value is improved and when the sensing responsiveness (rich sensitivity) of when the actual air-fuel ratio is changed to the rich value is improved.

When the sensing responsiveness (lean sensitivity) of when the actual air-fuel ratio is changed to the lean value is improved, as described above, when the negative constant current “Ics” is made to flow in such a way that the oxygen is supplied from the atmosphere electrode layer 34 to the exhaust electrode layer 33 through the solid electrolyte layer 32 (see FIG. 6A), as shown by a broken line (a) in FIG. 7, an output characteristic curve is shifted to a rich side. In more detail, the output characteristic curve is shifted so that the air-fuel ratio becomes richer and the electromotive force is decreased, whereby a voltage drop is caused in the output of the oxygen sensor 21. In this case, even if the actual air-fuel ratio is within a rich region near a stoichiometric air-fuel ratio, the sensor output becomes a lean output. That is, the sensing responsiveness (lean sensitivity) of when the actual air-fuel ratio is changed to the lean value is improved as the output characteristics of the oxygen sensor 21.

On the other hand, when the sensing responsiveness (rich sensitivity) of when the actual air-fuel ratio is changed to the rich value is improved, as described above, when the positive constant current “Ics” is made to flow in such a way that the oxygen is supplied from the exhaust electrode layer 33 to the atmosphere electrode layer 34 through the solid electrolyte layer 32 (see FIG. 6B), as shown by a broken line (b) in FIG. 7, the output characteristic curve is shifted to become lean. In more detail, the output characteristic curve is shifted to be lean and the electromotive force is increased, whereby a voltage rise is caused in the output of the oxygen sensor 21. In this case, even if the actual air-fuel ratio is within a lean region near the stoichiometric air-fuel ratio, the sensor output becomes a rich output. That is, the sensing responsiveness (lean sensitivity) of when the actual air-fuel ratio is changed to the rich value is improved as the output characteristics of the oxygen sensor 21.

However, in a system in which a constant current flows between the sensor electrodes to thereby change the output characteristics of the oxygen sensor 21, when a constant current is flows between the sensor electrodes, a voltage variation (voltage drop or voltage rise) is caused in the output of the oxygen sensor 21 due to an internal resistance of the oxygen sensor 21. Since the internal resistance of the oxygen sensor 21 is changed due to the individual difference, the secular change, and the temperature of the oxygen sensor 21, an amount of output-voltage-variation caused due to the internal resistance of the oxygen sensor 21 at the time of the constant current supply is also changed. For this reason, there is a possibility that the system suffers the effect of the output-voltage-variation caused due to the internal resistance of the oxygen sensor 21 at the time of the constant current supply and hence cannot perform the subordinate F/B control based on the output of the oxygen sensor 21 with high accuracy. Hence, there is a possibility that the control accuracy of the air-fuel ratio will be deteriorated to thereby impair an exhaust emission.

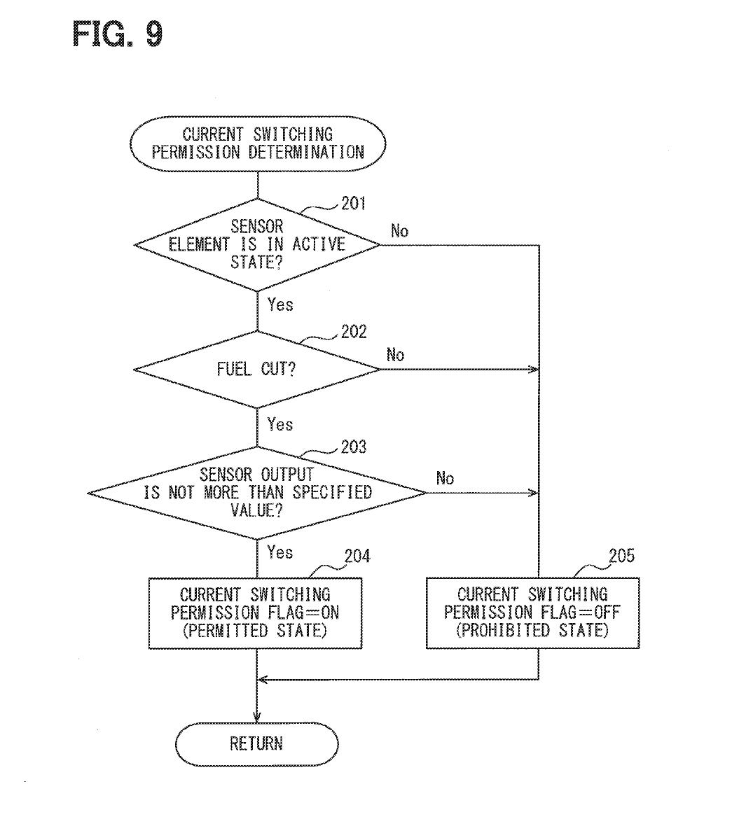

In the present embodiment 1, the ECU 25 (or the microcomputer 26) performs the respective routines shown in FIG. 9 to FIG. 11, which will be described later. In this way, when a current value of a constant current (direct current) flowing between the sensor electrodes is switched, the ECU 25 (or the microcomputer 26) computes the output-voltage-variation information (an amount of output-voltage-variation caused due to the internal resistance, or information correlated to the amount of output-voltage-variation) of the oxygen sensor 21 at the time of the constant current supply on the basis of the outputs of the oxygen sensor 21 before and after the current value of the constant current flowing between the sensor electrodes being changed. Then, at the time of the constant current supply (that is, when the output characteristics of the oxygen sensor 21 are changed), the ECU 25 (or the microcomputer 26) corrects the output of the oxygen sensor 21 on the basis of the output-voltage-variation information. In this way, the ECU 25 (or the microcomputer 26) can perform the subordinate F/B control based on the output of the oxygen sensor 21 in consideration of the output-voltage-variation information, which can prevent a malfunction caused by the output-voltage-variation caused due to the internal resistance of the oxygen sensor 21 at the time of the constant current supply.

Specifically, it is determined whether a current-switching-permission condition is met according to whether the output of the oxygen sensor 21 is not more than a specified value (for example, a value corresponding to an atmospheric state) during a fuel cutting period in which the injection of fuel into the engine 11 is stopped. Then, when the output of the oxygen sensor 21 is not more than the specified value during the fuel cutting period, it is determined that the current-switching-permission condition is met and a current switching permission flag is set on (in a permitted state), which indicates the permission of a current switching.

When the current switching permission flag is set on (in the permitted state), that is, when it is determined that the current-switching-permission condition is met, the current value of the constant current (direct current) flowing between the sensor electrodes is switched from “I1” to “I2”, and the direct current resistance value (internal resistance value) of the oxygen sensor 21 is computed as the output-voltage-variation information from a difference (V2−V1) in the output of the oxygen sensor 21 and a difference (“I2”−“I1”) in the current value between before and after switching the current value.

Then, at the time of the constant current supply in which the constant current flows between the sensor electrodes, in other words, when the output characteristics of the oxygen sensor 21 is changed, an amount of output-voltage-variation (an amount of output voltage drop or an amount of output voltage rise) is obtained from the constant current value and the current resistance value at that time, and the output of the oxygen sensor 21 is corrected by the use of the amount of output-voltage-variation. The ECU 25 performs the subordinate F/B control by the use of the output of the oxygen sensor 21 after the correction.

Hereinafter, the processing contents of the respective routines shown in FIG. 8 to FIG. 11, which are performed by the ECU 25 (or the microcomputer 26) in the present embodiment 1, will be described.

### [Sensor Responsiveness Control Routine]

A sensor responsiveness control routine shown in FIG. 8 is repeatedly performed at a specified period during a period in which the power of the ECU 25 is on. In the present routine, in steps 101 to 103, it is determined whether a change request for changing the sensing responsiveness of the oxygen sensor 21 is made, and in steps 104 to 107, a constant current control is performed on the basis of the determination result of the change request, thereby changing the sensing responsiveness of the oxygen sensor 21.

In step 101, it is determined whether the engine 11 is in a cold state in which the engine 11 is started based on whether any one of the following conditions (1) to (3) is satisfied.

(1) A coolant temperature of the engine 11 is not more than a specified temperature.

(2) An oil temperature (temperature of lubricant oil) of the engine 11 is not more than a specified temperature.

(3) A fuel temperature in a fuel path is not more than a specified temperature.

When it is determined in step 101 that the engine 11 is in the cold state, it is determined that the change request for improving the rich responsiveness (sensing responsiveness when the actual air-fuel ratio is changed to the rich value) is made. In this case, the routine proceeds to step 104 in which the supply of the constant current “Ics” is controlled on the basis of the change request for improving the rich responsiveness. Specifically, “the positive constant current Ics” is set as the constant current of the constant current circuit 27. At this time, the constant current circuit 27 is controlled by the microcomputer 26, whereby the constant current “Ics” (positive constant current “Ics”) is made to flow in the direction in which oxygen is supplied from the exhaust electrode layer 33 to the atmosphere electrode layer 34. In this way, when the engine 11 is in the cold state, the rich responsiveness of the oxygen sensor 21 is improved. In this regard, it is recommended that the amount of the constant current is a specified value determined previously.

When it is determined in step 101 that the engine 11 is not in the cold state, the routine proceeds to step 102. In step 102, it is determined whether the engine 11 is in a high-load operating state based on whether any one of the following conditions (4) to (6) is satisfied.

(4) An amount of air introduced into the cylinder is not less than a specified amount.

(5) A combustion pressure in the cylinder is not less than a specified value.

(6) An accelerator opening is not less than a specified value.

When it is determined in this step 102 that the engine 11 is in the high-load operating state, it is determined that the change request for improving the lean responsiveness (sensing responsiveness when the actual air-fuel ratio is changed to the lean value) is made. In this case, the routine proceeds to step 105 in which the supply of the constant current “Ics” is controlled on the basis of the change request for improving the lean responsiveness. Specifically, “the negative constant current Ics” is set as the constant current of the constant current circuit 27. At this time, the constant current circuit 27 is controlled by the microcomputer 26, whereby the constant current “Ics” (negative constant current “Ics”) is made to flow in the direction in which oxygen is supplied from the atmosphere electrode layer 34 to the exhaust electrode layer 33. In this way, when the engine 11 is in the high-load operating state, the lean responsiveness of the oxygen sensor 21 is improved. In this regard, it is recommended that the amount of the constant current is a specified value determined previously.

The high-load operating state of the engine 11 includes a transient period in which an engine load is increased and a high-load steady period in which the engine load is increased. In this case, in the transient period and in the high-load steady period, the lean responsiveness is improved. However, when the sensing responsiveness is improved, a responsiveness level required as the sensing responsiveness may be different between in the transient period and in the high-load steady period.

Specifically, the responsiveness level in the transient period is made higher than the responsiveness level in the high-load steady period. In other words, when it is determined that the engine 11 is in the high-load operating state, it is further determined whether the engine load is in the transient period or in the high-load steady period. A determination that the engine load is in the transient period corresponds to a determination that a change request for improving the lean responsiveness and for comparatively deteriorating the responsiveness level (deteriorating the responsiveness level more than in the high-load steady period) is made. On the other hand, a determination that the engine load is in the high-load steady period corresponds to a determination that a change request for improving the lean responsiveness and for comparatively improving the responsiveness level (improving the responsiveness level more than in the transient period) is made. Then, in each of the case where the engine load is in the transient period and the case where the engine load is in high-load steady period, the supply of the constant current “Ics” is controlled on the basis of the change request.

On the other hand, when it is determined in step 102 described above that the engine 11 is not in the high-load operating state, the routine proceeds to step 103 in which it is determined whether: this timing is just after a fuel cutting state is returned to a fuel injecting state; and a rich injection control for neutralizing both catalysts 18, 19 is performed. The rich injection control is an air-fuel ratio control of temporally enriching the air-fuel ratio in order to relieve a state in which both catalysts 18, 19 are in an excess oxygen state (extremely lean atmosphere) on the basis of the sensed result of the oxygen sensor 21 when the engine 11 is returned from the fuel cutting state. In the rich injection control, the atmospheres of both catalysts 18, 19 are neutralized by enriching the amount of fuel injection (the actual air-fuel ratio is held close to the stoichiometric air-fuel ratio). Then, the rich injection control is finished at the timing when the output of the oxygen sensor 21 is shifted from a lean value to a rich value after returning from the fuel cutting state. In the present embodiment, when the rich injection control is performed, the sensing responsiveness when the actual air-fuel ratio is changed to the rich value is deteriorated.

When it is determined in this step 103 that the rich injection control is performed, it is determined that a change request for decreasing a rich responsiveness (sensing responsiveness when the actual air-fuel ratio is changed to the rich value) is made. In this case, the routine proceeds to step 106 in which the supply of the constant current “Ics” is controlled on the basis of the change request for deteriorating the rich responsiveness. Specifically, “the negative constant current Ics” is set as the constant current of the constant current circuit 27 (which is the same as when the lean responsiveness is improved). At this time, the constant current circuit 27 is controlled by the microcomputer 26, which results in making the constant current “Ics” (negative constant current “Ics”) flow in the direction in which the oxygen is supplied from the atmosphere electrode layer 34 to the exhaust electrode layer 33. In this way, when the rich injection control is performed, the rich responsiveness is deteriorated. In this regard, it is recommended that the amount of constant current may be a specified value determined in advance.

When determination results in all of the steps 101 to 103 described above are “NO”, the routine proceeds to step 107 in which a control of not changing the sensing responsiveness of the oxygen sensor 21 with respect to a reference responsiveness, that is, a control of “constant current Ics=0” is performed.

In the routine shown in FIG. 8, all of the processing (steps 101, 104) of improving the rich responsiveness of the oxygen sensor 21 when the engine 11 is in the cold state, the processing (steps 102, 105) of improving the lean responsiveness of the oxygen sensor 21 when the engine 11 is in the high-load operating state, and the processing (steps 103, 106) of deteriorating the rich responsiveness of the oxygen sensor 21 when the rich injection control is performed are performed. However, the present processing is not limited to these pieces of processing, but any one processing or any two pieces of processing may be performed.

Further, a state in which the lean responsiveness is improved and a state in which the rich responsiveness is improved may be switched each other by switching the direction in which the constant current to be made to flow between the sensor electrodes in accordance with the air-fuel ratio being changed to the rich value and the lean value. In this case, the magnitude of the constant current to be made to flow between the sensor electrodes may be changed according to the engine operating state (for example, engine rotation speed or the load).

### [Current Switching Permission Determination Routine]

A current switching permission determination routine shown in FIG. 9 is repeatedly performed during a period in which the power of the ECU 25 is on, thereby playing a role as a determination portion. When the present routine is invoked, it is determined in steps 201 to 203 whether a current-switching-permission condition is met.

Whether or not the sensor element 31 is in an active state is determined in step 201, for example, based on whether an element impedance is not more than a specified value (for example, 100Ω) or based on whether a current passing time of a heater 36 is not less than a specified time.

When it is determined in this step 201 that the sensor element 31 is in the active state, the routine proceeds to step 202 in which it is determined whether the fuel is held cut off. When it is determined that the fuel is held cut off, the routine proceeds to step 203 in which it is determined whether the output of the oxygen sensor 21 is not more than a specified value. The specified value is set at a value (for example, a value not more than 0.05 V) corresponding to an atmospheric state (lean state).

When the determination results in all of the steps 201 to 203 are “YES” (it is determined that the output of the oxygen sensor 21 is made not more than the specified value while the fuel is held cut off), it is determined that there is brought about a state in which the output of the oxygen sensor 21 is in a stable state on a lean side and hence it is determined that the current-switching-permission condition is met. Then, the routine proceeds to step 204 in which a current switching permission flag is set on (in a permitted state), which means the permission of the current switching.

On the other hand, when the determination result in any one of the steps 201 to 203 described above is “NO”, it is determined that the current-switching-permission condition is not met and the routine proceeds to step 205 in which the current switching permission flag is held set off (in a prohibited state), which means that the prohibition of the current switching, or reset.

### [Direct Current Resistance Value Computation Routine]

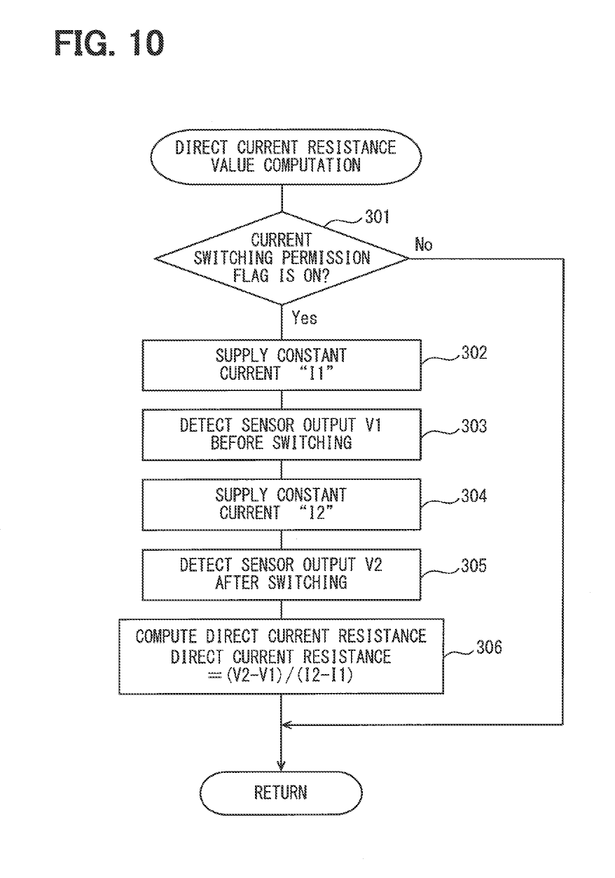

A direct current resistance value computation routine shown in FIG. 10 is repeatedly performed at a specified period during a period in which the power or the ECU 25 is on, thereby playing a role as an output-voltage-variation information computing portion. When the present routine is invoked, first, in step 301, it is determined whether the current-switching-permission condition is met based on whether the current switching permission flag is off (in a permitted state).

When it is determined in this step 301 that the current switching permission flag is off (in a prohibited state), it is determined that the current switching permission is not met and hence the pieces of processing in the step 302 and in the subsequent steps are not performed but the present routine is finished.

On the other hand, when it is determined in this step 301 that the current switching permission flag is on (in the permitted state), it is determined that the current-switching-permission condition is met and the pieces of processing of step 302 and subsequent steps are performed in the following way.

In step 302, the constant current circuit 27 is controlled in such a way that the constant current “I1” is made to flow between the sensor electrodes (between the exhaust electrode layer 33 and the atmosphere electrode layer 34). The constant current “I1” is set at, for example, 0 mA. In this case, the constant current flowing between the sensor electrodes results in being made 9 mA.

Thereafter, the routine proceeds to step 303 in which the output of the oxygen sensor 21 when the constant current “I1” is made to flow between the sensor electrodes (for example, when the constant current flowing between the sensor electrodes is made 0 mA) is sensed as a sensor output V1 before switching. In this case, the output of the oxygen sensor 21 is sensed multiple times and the average value of the sensed outputs of the oxygen sensor 21 is made the sensor output V1 before switching.

Then, the routine proceeds to step 304 in which the constant current circuit 27 is controlled in such a way as to make the constant current “I2” flow between the sensor electrodes. The constant current “I2” is set at a value (for example, 0.1 to 10 mA), which is larger than an AD conversion error and can surely sense a voltage difference and does not cause damage to the oxygen sensor 21.

Then, the routine proceeds to step 305 in which the output of the oxygen sensor 21 when the constant current “I2” is made to flow between the sensor electrodes is sensed as a sensor output V2 after switching. In this case, the output of the oxygen sensor 21 is sensed multiple times and the average value of the sensed outputs of the oxygen sensor 21 is established as the sensor output V2 after switching.

Then, the routine proceeds to step 306 in which the direct current resistance value (internal resistance value) of the oxygen sensor 21 is computed from a difference (V2−V1) in the output of the oxygen sensor 21 and a difference (I2−I1) in the current value between before and after switching the current value.

Direct current resistance value=(V2−V1)/(I2−I1)

### [Sensor Output Correction Routine]

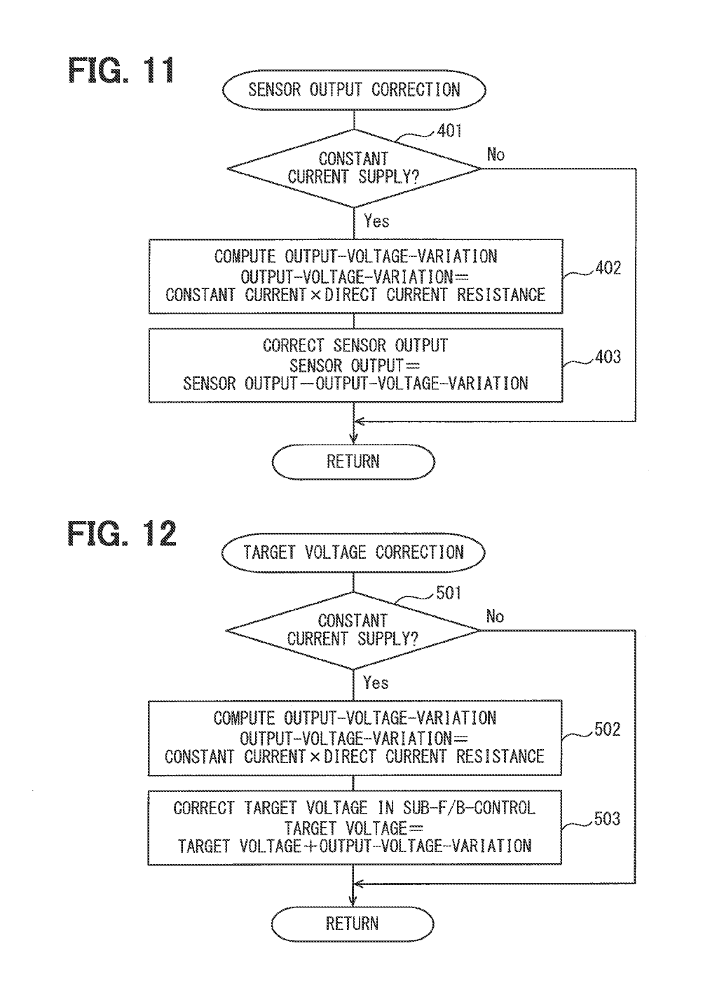

A sensor output correction routine shown in FIG. 11 is repeatedly performed at a specified period during a period in which the power or the ECU 25 is on, thereby playing a role as a sensor-output-correction portion. When the present routine is invoked, first, in step 401, it is determined whether a constant current supply in which the constant current is made to flow between the sensor electrodes is being performed (in other words, the output characteristics of the oxygen sensor 21 is being changed). When it is determined that the constant current supply is being performed, the routine proceeds to step 402 in which the amount of output-voltage-variation (the amount of output voltage drop or the amount of output voltage rise) caused by the internal resistance of the oxygen sensor 21 when the constant current supply is performed is computed by the following formula by the use of the present constant current value and the direct current resistance value (internal resistance value) of the oxygen sensor 21.

Output-voltage-variation=Constant current×Direct current resistance

At this time, for example, the amount of output-voltage-variation when the constant current is made to flow in the direction in which the output voltage of the oxygen sensor 21 is lowered (that is, the amount of output voltage drop) is assumed to be a negative value, whereas the amount of output-voltage-variation when the constant current is made to flow in the direction in which the output voltage of the oxygen sensor 21 is raised (that is, the amount of output voltage rise) is assumed to be a positive value.

Then, the routine proceeds to step 403 in which the sensor output (output of the oxygen sensor 21) is corrected by the following formula by the use of the amount of output-voltage-variation.

Sensor Output=(Sensor Output)−(Output-voltage-variation)

The ECU 25 performs the subordinate F/B control by the use of the sensor output (output of the oxygen sensor 21) after the correction.

In the present embodiment 1 described above, by making the constant current flow between the sensor electrodes by the constant current circuit 27 provided in the outside of the oxygen sensor 21, the output characteristics of the oxygen sensor 21 can be changed and hence the lean responsiveness and the rich responsiveness can be improved. In addition, an auxiliary electrochemical battery or the like does not need to be built in the oxygen sensor 21, so that the output characteristics of the oxygen sensor 21 can be changed without causing a significant change in design and an increase in cost.

At the time of the constant current supply in which the constant current is made to flow between the sensor electrodes (in other words, the output characteristics of the oxygen sensor 21 are changed), the voltage variation (voltage drop or voltage rise) is caused in the output of the oxygen sensor 21 by the internal resistance of the oxygen sensor 21. In the present embodiment 1, however, the direct current resistance value (internal resistance value) of the oxygen sensor 21 is computed from the difference in the output of the oxygen sensor 21 and the difference in the current value between before and after switching the value of the current flowing between the sensor electrodes, and at the time of the constant current supply, the amount of output-voltage-variation (the amount of output voltage drop or the amount of the output voltage rise) is found from the constant current value and the direct current resistance value at that time, and the output of the oxygen sensor 21 is corrected by the use of the amount of output-voltage-variation. Hence, even when the constant current value at the time of the constant current supply is changed, for example, according to the engine operating state or the like, the amount of output-voltage-variation (the amount of output voltage drop or the amount of output voltage rise) can be found with high accuracy from the constant current value and the direct current resistance value at the time of the constant current supply and the output of the oxygen sensor 21 can be corrected with high accuracy by the use of the amount of output-voltage-variation. In this way, the subordinate FIB control based on the output of the oxygen sensor 21 can be performed with high accuracy without suffering the effect of the output-voltage-variation caused by the internal resistance of the oxygen sensor 21 and hence a deterioration in the accuracy of the air-fuel ratio control, which is caused by the output-voltage-variation caused by the internal resistance of the oxygen sensor 21, can be prevented and an exhaust emission can be prevented from becoming worse.

In addition, when the value of the current flowing between the sensor electrodes is switched, the direct resistance value (internal resistance value) is computed on the basis of the output of the oxygen sensor 21 before and after the switching and the amount of output-voltage-variation is computed by the use of the direct resistance value (internal resistance value). For this reason, even if the internal resistance is changed by the individual difference (variations in manufacturing), the secular change, and the temperature of the oxygen sensor 21 and hence the amount of output-voltage-variation caused by the internal resistance is changed, the internal resistance at that time and the amount of output-voltage-variation corresponding to the internal resistance can be found with high accuracy.

Further, the direct current resistance value (internal resistance value) is computed on the basis of the output of the oxygen sensor 21 before and after switching the current value of the constant current (direct current) flowing between the sensor electrodes without supplying an alternating current, and the amount of output-voltage-variation is computed by the use of the direct current resistance value (internal resistance value). For this reason, the internal resistance and the amount of output-voltage-variation corresponding to the internal resistance can be found with high accuracy without suffering the effect of the electrostatic capacity of the oxygen sensor 21. In addition, a circuit for supplying the alternating current and a band pass filter do not need to be provided and hence a circuit configuration can be simplified.

Still further, in the present embodiment 1, it is determined whether the specified current-switching-permission condition is met and when it is determined that the specified current-switching-permission condition is met, the value of the current flowing between the sensor electrodes is switched and the output-voltage-variation information (in the present embodiment 1, the direct current resistance value of the oxygen sensor 21) is computed. Hence, when the specified current-switching-permission condition is met and there is brought about a state suitable for operating the output-voltage-variation information (for example, a state in which the output of the oxygen sensor 21 is made stable), the value of the current flowing between the sensor electrodes is switched and the output-voltage-variation information can be computed, whereby the accuracy of the computation of the output-voltage-variation information can be improved.

In the present embodiment 1, attention is focused on that during the fuel cutting period of the engine 11, a lean gas flows in the exhaust pipe 17 to thereby bring the interior of the exhaust pipe 17 into a lean state, and when it is determined during the fuel cutting period that the output of the oxygen sensor 21 is made not more than a specified value, it is determined that the output of the oxygen sensor 21 is in a stable state on a lean side and that the current-switching-permission condition is met. Hence, when the output of the oxygen sensor 21 is brought into the stable state on the lean side during the fuel cutting period, the output-voltage-variation information can be computed by switching the value of the current flowing between the sensor electrodes.

In the present embodiment 1, considering that when the value of the current flowing between the sensor electrodes becomes 0, an error included in the output of the oxygen sensor 21 becomes small, at the time of switching the value of the current flowing between the sensor electrodes, the value of the current before switching is made 0. Hence, the accuracy of the computation of the output-voltage-variation information based on the output of the oxygen sensor 21 can be further improved.

### Embodiment 2

Next, an embodiment 2 of the present invention will be described by the use of FIG. 12. However, the descriptions of the parts substantially identical to those in the embodiment 1 will be omitted or simplified and parts different from those in the embodiment 1 will be mainly described.

In the embodiment 1, the output of the oxygen sensor 21 is corrected by the use of the amount of output-voltage-variation found from the constant current value and the direct current resistance value at the time of the constant current supply. In the present embodiment 2, however, the ECU 25 (or the microcomputer 26) performs a target voltage correction routine shown in FIG. 12, which will be described later, thereby correcting a target voltage of the subordinate F/B control by the use of the amount of output-voltage-variation found from the constant current value and the direct current resistance value at the time of the constant current supply.

The target voltage correction routine shown in FIG. 12 is repeatedly performed at a specified period during a period in which the power of the ECU 25 is on, thereby playing a role as a target-value-correction portion. When the present routine is invoked, first, in step 501, it is determined whether the constant current supply in which the constant current is made to flow between the sensor electrodes is being performed (in other words, the output characteristics of the oxygen sensor 21 is being changed), and when it is determined that the constant current supply is being performed, the routine proceeds to step 502 in which the amount of output-voltage-variation (the amount of output voltage drop or the amount of output voltage rise) caused by the internal resistance of the oxygen sensor 21 at the time of the constant current supply is found by the following formula by the use of the present constant current value and the direct current resistance value (internal resistance value) of the oxygen sensor 21.

Amount of output-voltage-variation=constant current value×direct current resistance value

At this time, for example, the amount of output-voltage-variation when the constant current is made to flow in the direction in which the output voltage of the oxygen sensor 21 is lowered (that is, the amount of output voltage drop) is assumed to be a negative value and the amount of output-voltage-variation when the constant current is made to flow in the direction in which the output voltage of the oxygen sensor 21 is raised (that is, the amount of output voltage rise) is assumed to be a positive value.

Thereafter, the routine proceeds to step 503 in which the target voltage of the subordinate F/B control is corrected by the following formula by the use of the amount of output-voltage-variation.

Target voltage=Target voltage+Output-voltage-variation

The ECU 25 performs the subordinate F/B control by the use of the target voltage after this correction.

In the embodiment 2 described above, at the time of the constant current supply, the amount of output-voltage-variation (the amount of output voltage drop or the amount of output-voltage-variation rise) is computed from the constant current value and the direct current resistance value at that time and the target voltage of the subordinate F/B control is corrected by the use of the amount of output-voltage-variation. Hence, for example, even when the constant current at the time of the constant current supply is changed according to the engine operating state or the like, the amount of output-voltage-variation (the amount of output voltage drop or the amount of output-voltage-variation rise) can be found with high accuracy from the constant current value and the direct current resistance value at the time of the constant current supply and the target voltage of the subordinate F/B control can be corrected with high accuracy by the use of the amount of output-voltage-variation. Hence, the nearly same effect as the embodiment 1 can be obtained.

In the examples 1, 2 described above, when the current-switching-permission condition is met, the direct current resistance value of the oxygen sensor 21 is computed as the output-voltage-variation information, but the computation of the output-voltage-variation information is not limited to this. For example, when the constant current value at the time of the constant current supply is fixed at a specified value V0 regardless of the engine operating state or the like, it is also recommended that when the current-switching-permission condition is met, the value of the current flowing between the sensor electrodes be switched from 0 to a specified value V0 (in other words, the same value as the constant current value at the time of the constant current supply) and the amount of output-voltage-variation be found from a difference in the output of the oxygen sensor 21 between before and after switching the value of the current.

### Embodiment 3

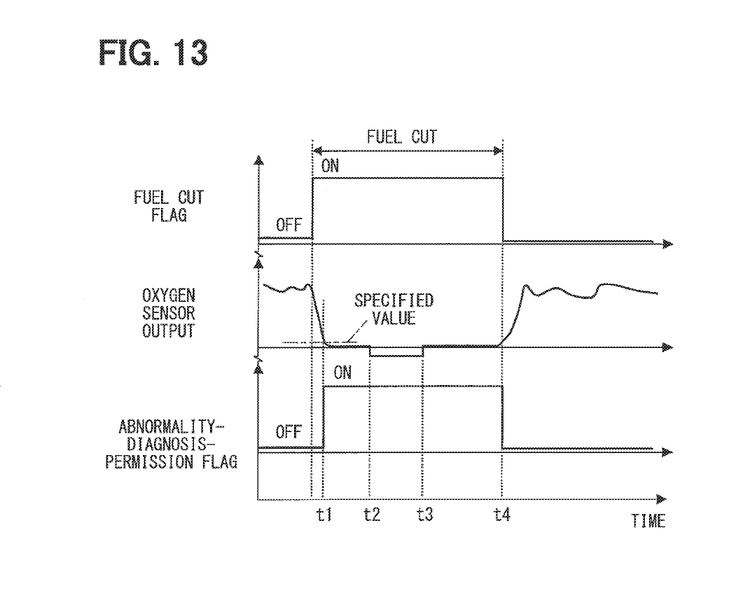

Next, an embodiment 3 of the present invention will be described by the use of FIG. 13 to FIG. 16. However, the descriptions of the parts substantially identical to those in the embodiment 1 will be omitted or simplified and parts different from those in the embodiment 1 will be mainly described.

If an abnormality (for example, failure or the like) is caused in the constant current circuit 27 for making the constant current flow between the sensor electrodes, there is a possibility that since the output characteristics of the oxygen sensor 21 cannot be appropriately changed and the control based on the output of the oxygen sensor 21 (for example, the subordinate F/B control or the like) cannot be performed, the exhaust emission will be impaired. Hence, when an abnormality is caused in the constant current circuit 27, the abnormality needs to be quickly detected.

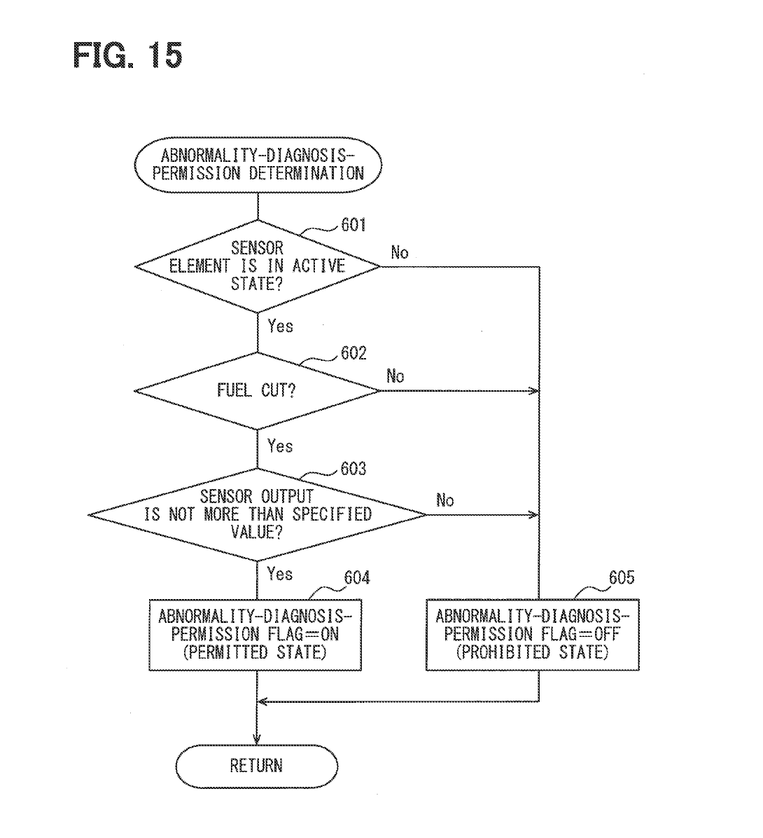

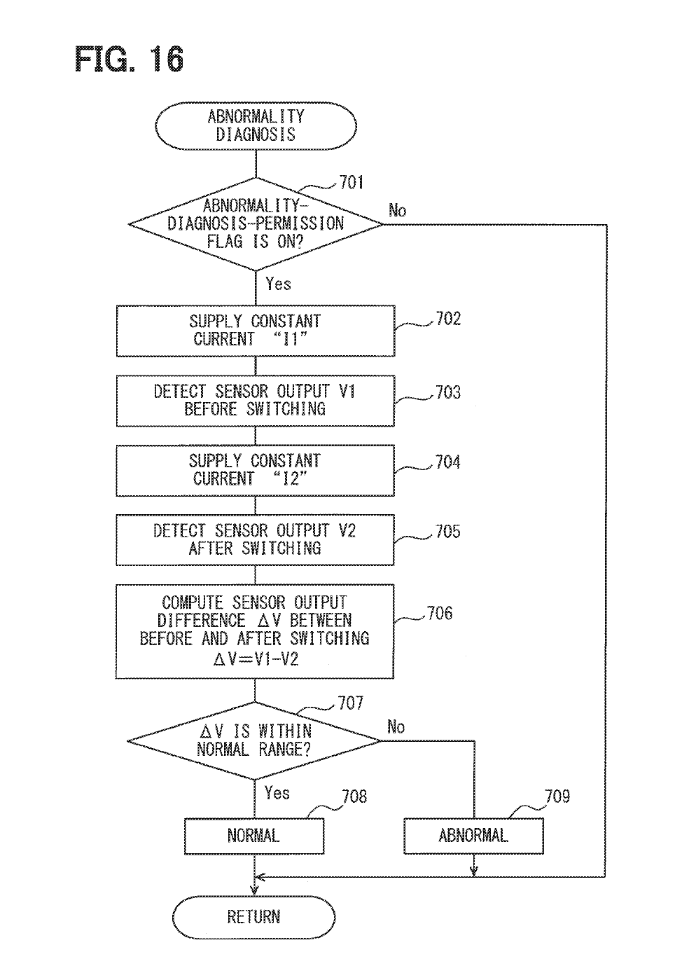

In the embodiment 3, the ECU 25 (or the microcomputer 26) performs the respective routines shown in FIG. 15 and FIG. 16, thereby making an abnormality diagnosis for determining whether an abnormality (for example, a failure or the like) is caused in the constant current circuit 27 in the following manner.

As shown by a time chart in FIG. 13, first, it is determined whether an abnormality-diagnosis-performance condition is met based on whether the output of the oxygen sensor 21 is made not more than a specified value (for example, a value corresponding to an atmospheric state) during a fuel cutting period in which the injection of fuel into the engine 11 is stopped. Then, at a timing t1 when the output of the oxygen sensor 21 is made not more than the specified value during the fuel cutting period, it is determined that the abnormality-diagnosis-performance condition is met and an abnormality-diagnosis-permission flag is set on, which means the permission of the abnormality diagnosis. In this case, the abnormality-diagnosis-performance condition corresponds to the current-switching-permission condition.

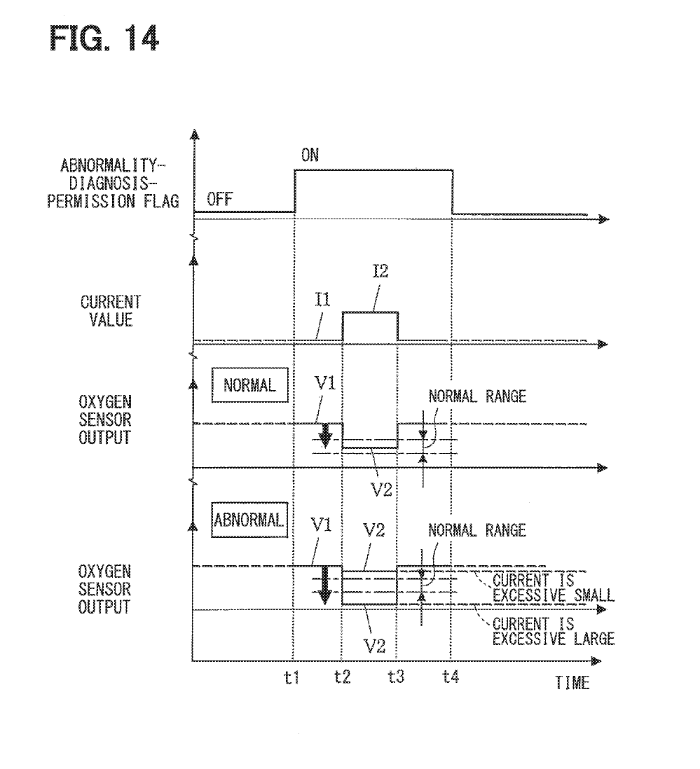

As shown by a time chart in FIG. 14, when the abnormality-diagnosis-permission flag is set on (in the permitted state) (that is, when it is determined that the abnormality-diagnosis-performance condition is met), the value of the current flowing between the sensor electrodes is switched from “I1” to “I2” and an abnormality diagnosis for determining whether an abnormality is caused in the constant current circuit 27 is performed based on whether a difference ΔV (=V1−V2) in the output of the oxygen sensor 21 between before and after switching the value of the current is within a specified normal range. In this case, the difference ΔV in the output of the oxygen sensor 21 corresponds to the output-voltage-variation information.

In a period from the timing t1 to a timing t2, the output of the oxygen sensor 21 when the constant current “I1” is made to flow between the sensor electrodes is sensed multiple times and an average value of the outputs of the oxygen sensor 21 is calculated and is established as a sensor output V1 before the switching. Thereafter, at the timing t2, the value of the current flowing between the sensor electrodes is switched from “I1” to “I2”, and in a period from the timing t2 to a timing t3, the output of the oxygen sensor 21 when the constant current “I2” is made to flow between the sensor electrodes is sensed multiple times and an average value of the outputs of the oxygen sensor 21 is calculated and is made a sensor output V2 after the switching.

Then, at the timing t3, a difference ΔV in the sensor output between before and after the switching (that is, a difference between the sensor output V1 before the switching and the sensor output V2 after the switching) is computed, and an abnormality diagnosis of the constant current circuit 27 is performed based on whether the difference ΔV in sensor output between before and after the switching is within a specified normal range. Then, after the abnormality diagnosis is finished, the value of the constant current flowing between the sensor electrodes is returned to an original value.

When an abnormality (for example, a failure or the like) is caused in the constant current circuit 27, the behavior of the output of the oxygen sensor 21 when the value of the current flowing between the sensor electrodes becomes different from the behavior of the output of the oxygen sensor 21 when the constant current circuit 27 is normal. Hence, when the value of the current flowing between the sensor electrodes is switched, an abnormality diagnosis of determining whether an abnormality is caused in the constant current circuit 27 is performed based on whether the difference in the output of the oxygen sensor 21 between before and after the switching is within the specified normal range. In this way, it can be determined whether an abnormality is caused in the constant current circuit 27 with high accuracy.

Then, after a timing t4 when it is determined that the abnormality-diagnosis-performance condition is not met and the abnormality-diagnosis-permission flag is set off (in a prohibited state) or reset, which means that the abnormality diagnosis is prohibited, a normal sensor responsiveness control (see FIG. 8) is performed.

Hereinafter, the processing contents of the respective routines shown in FIG. 15 and FIG. 16, which are performed by the ECU 25 (or the microcomputer 26) in the present embodiment 3, will be described.

### [Abnormality-Diagnosis-Permission Determination Routine]

An abnormality-diagnosis-permission determination routine shown in FIG. 15 is repeatedly performed at a specified period during a period in which the power of the ECU 25 is on, thereby playing a role as a determination portion. In steps 601 to 603, it is determined whether the abnormality-diagnosis-performance condition (the same condition as the current-switching-permission condition described in the steps 201 to 203 of the routine shown in FIG. 9) is met.

In step 601, it is determined whether the sensor element 31 is in an active state, for example, based on whether the impedance of the sensor element 31 is not more than a specified value (for example, 100Ω) or based on whether the current passing time of a heater 36 is not less than a specified time.

When it is determined in this step 601 that the sensor element 31 is in the active state, the routine proceeds to step 602 in which it is determined whether the fuel is being cut. When it is determined that the fuel is being cut, the routine proceeds to step 603 in which it is determined whether the output of the oxygen sensor 21 is not more than a specified value. The specified value is set at a value (for example, a value not more than 0.05 V) corresponding to the atmospheric state (lean state).

When determination results in all of the steps 601 to 603 are “YES” (it is determined that the output of the oxygen sensor 21 is not more than the specified value in the fuel cutting period), it is determined that the output of the oxygen sensor 21 is in an stable state on the lean side and that the abnormality-diagnosis-performance condition is met. Then, the routine proceeds to step 604 in which an abnormality-diagnosis-permission flag is set on (in the permitted state), which means the permission of the abnormality diagnosis.

On the other hand, when the determination result in any one of the steps 601 to 603 is “NO”, it is determined that the abnormality-diagnosis-performance condition is not met. Then, the routine proceeds to step 605 in which the abnormality-diagnosis-permission flag is set off (in the prohibited state), which means the prohibition of the abnormality diagnosis.

### [Abnormality Diagnosis Routine]

An abnormality diagnosis routine shown in FIG. 16 is repeatedly performed at a specified period during a period in which the power of the ECU 25 is on, thereby playing a role as an output-voltage-variation information computing portion and an abnormality diagnosis portion. In step 701, it is determined whether the abnormality-diagnosis-performance condition is met based on whether the abnormality-diagnosis-permission flag is on (in the permitted state).

When it is determined in this step 701 that the abnormality-diagnosis-permission flag is off (in the prohibited state), it is determined that the abnormality-diagnosis-performance condition is not met and hence the present routine is finished without performing the pieces of processing in step 702 and in the subsequent steps, which relate to the abnormality diagnosis.

On the other hand, when it is determined in the step 701 that the abnormality-diagnosis-permission flag is on (in the permitted state), it is determined that the abnormality-diagnosis-performance condition is met and the processing in step 702 and the subsequent steps, which relate to the abnormality diagnosis, are performed in the following manner.

In step 702, the constant current circuit 27 is controlled in such a way as to make the constant current “I1” flow between the sensor electrodes (between the exhaust electrode layer 33 and the atmosphere electrode layer 34). The constant current “I1” is set, for example, at 0 mA. In this case, the constant current flowing between the sensor electrodes is made 0 mA.

Then, the routine proceeds to step 703 in which the output of the oxygen sensor 21 when the constant current “I1” is made to flow between the sensor electrodes (for example, when the constant current flowing between the sensor electrodes is set at 0 mA) is sensed as a sensor output V1 before the switching. In this case, the output of the oxygen sensor 21 is sensed multiple times and an average value of the outputs of the oxygen sensor 21 is made the sensor output V1 before the switching.

When the responsiveness of the output of the oxygen sensor 21 to a change in the current flowing between the sensor electrodes is low, if the sensing of the sensor output V1 is started after waiting for the output of the oxygen sensor 21 to converge, the time required for sensing the sensor output V1 will be elongated. Hence, the sensing of the sensor output V1 may be started in step 703 after the constant current circuit 27 is controlled in step 702 in such a way as to make the constant current “I1” flow and then a specified time has passed. In this way, even when the responsiveness of the output of the oxygen sensor 21 is low, the sensing of the sensor output V1 can be started without waiting for the output of the oxygen sensor 21 to converge.

Then, the routine proceeds to step 704 in which the constant current circuit 27 is controlled in such a way as to make the constant current “I2” flow between the sensor electrodes. The constant current “I2” is set at a value (for example, 0.1 to 10 mA), which is larger than an AD conversion error and makes it possible to reliably sense a voltage difference and does not cause damage to the oxygen sensor 21.

Then, the routine proceeds to step 705 in which the output of the oxygen sensor 21 of when the constant current “I2” is made to flow between the sensor electrodes is sensed as a sensor output V2 after the switching. In this case, for example, the output of the oxygen sensor 21 is sensed multiple times and an average value of the outputs of the oxygen sensor 21 is made a sensor output V2 after the switching.

When the responsiveness of the output of the oxygen sensor 21 with respect to a change in the current flowing between the sensor electrodes is low, when the sensing of the sensor output V1 is started after waiting for the output of the oxygen sensor 21 to converge, the time required for sensing the sensor output V1 will be elongated. Hence, the sensing of the sensor output V2 may be started in step 705 after the constant current circuit 27 is controlled in step 704 in such a way as to make the constant current “I2” flow and a specified time has passes. In this way, even when the responsiveness of the output of the oxygen sensor 21 is low, the sensing of the sensor output V2 can be started without waiting for the output of the oxygen sensor 21 to converge.

Then, the routine proceeds to step 706 in which a sensor output difference ΔV between before and after the switching (difference between the sensor output V1 before the switching and the sensor output V2 after the switching) is computed.

ΔV=V1−V2

Then, the routine proceeds to step 707 in which it is determined whether the sensor output difference ΔV between before and after the switching is within a specified normal range. The specified normal range is set, for example, on the basis of the constant currents “I1”, “I2” before and after the switching.

The normal range is set in consideration of a change in the sensor output characteristics caused by a change in the internal resistance of the oxygen sensor 21. In other words, the specified normal range is set at a value larger than a variation width of the sensor output characteristics caused by the change in the internal resistance of the oxygen sensor 21 (when a change is larger than the change in the sensor output characteristics caused by the change in the internal resistance of the oxygen sensor 21, it is determined that the constant current circuit 27 is abnormal).

When it is determined that the sensor output difference ΔV between before and after the switching is within the specified normal range in step 707, the routine proceeds to step 708 in which it is determined that the constant current circuit 27 is not abnormal (is normal).

On the other hand, when it is determined that the sensor output difference ΔV between before and after the switching is not within the specified normal range (in other words, outside the specified normal range) in the step 707, the routine proceeds to step 709 in which it is determined that the constant current circuit 27 is abnormal (for example, is failed). In this case, for example, an abnormality flag is set on and an alarm lamp (not shown in the drawing) provided in an instrument panel of a driver's seat is lit or blinked. Alternatively, an alarm is displayed on an alarm display part (not shown in the drawing) of the instrument panel of the driver's seat to thereby give an alarm to the driver and its alarm information (alarm code or the like) is stored in a rewritable non-volatile memory (rewritable memory for holding stored data even when the power of the ECU 25 is turned off) such as a backup RAM (not shown in the drawing) of the ECU 25.

In the present embodiment 3 described above, attention is focused on that when an abnormality (for example, a failure or the like) is caused in the constant current circuit 27, the behavior of the output of the oxygen sensor 21 of when the value of the current flowing between the sensor electrodes is switched is different from the behavior of the output of the oxygen sensor 21 of when the constant current circuit 27 is normal. When the value of the current flowing between the sensor electrodes is switched, the abnormality diagnosis for determining whether the abnormality is caused in the constant current circuit 27 is performed based on whether the difference in the output of the oxygen sensor 21 between before and after the switching is within the specified normal range. Hence, it is possible to determine with high accuracy whether the abnormality is caused in the constant current circuit 27. Hence, when an abnormality is caused in the constant current circuit 27, the abnormality can be sensed quickly.

Further, in the present embodiment 3, it is determined whether the specified abnormality-diagnosis-performance condition is met. When it is determined that the specified abnormality-diagnosis-performance condition is met, the value of the current flowing between the sensor electrodes is switched to thereby perform the abnormality diagnosis. Hence, when the specified abnormality-diagnosis-performance condition is met and a state suitable for performing the abnormality diagnosis (for example, a state in which the output of the oxygen sensor 21 is stable) is established, the abnormality diagnosis can be performed by switching the value of the current flowing between the sensor electrodes. Hence, the accuracy of the abnormality diagnosis can be improved.

Still further, in the present embodiment 3, in view of a fact that the lean gas flows in the exhaust pipe 17 to thereby bring the interior of the exhaust pipe 17 into a lean state during the fuel cut period of the engine 11, when it is determined that the output of the oxygen sensor 21 is made not more than a specified value in the fuel cut period, it is determined that the output of the oxygen sensor 21 is in a stable lean state and it is determined that the abnormality-diagnosis-performance condition is met. Hence, when the output of the oxygen sensor 21 is brought into the stable lean state in the fuel cut period, by switching the value of the current flowing between the sensor electrodes, the abnormality diagnosis can be performed.

### Embodiment 4

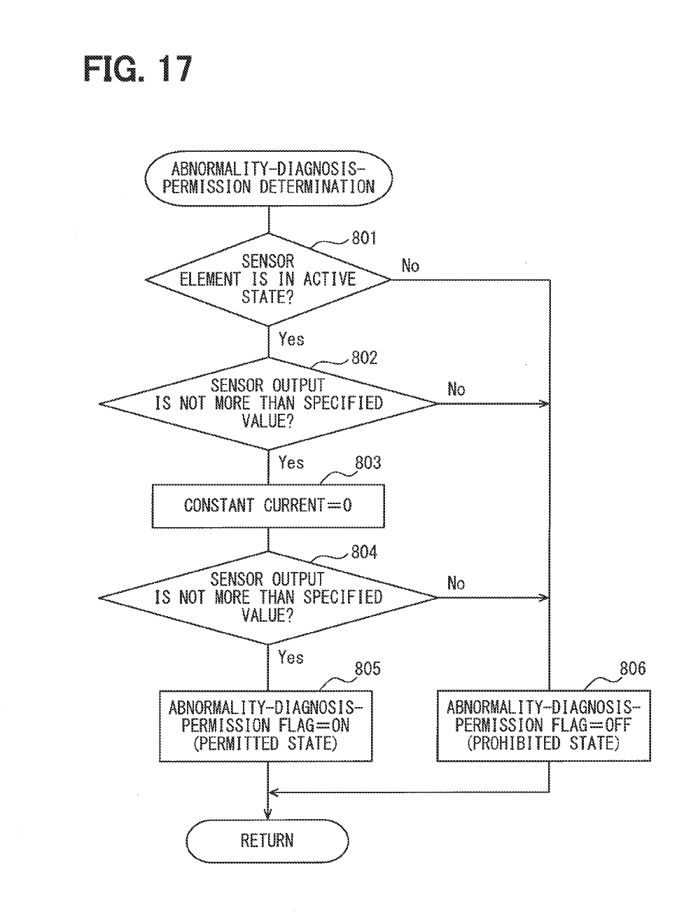

Next, an embodiment 4 of the present invention will be described by the use of FIG. 17. However, the descriptions of the parts substantially identical to those in the embodiment 3 will be omitted or simplified and parts different from those in the embodiment 3 will be mainly described.

In the present embodiment 4, the ECU 25 (or the microcomputer 26) performs an abnormality-diagnosis-permission determination routine shown in FIG. 17, which will be described later, thereby it is determined whether the abnormality-diagnosis-performance condition is met based on whether the output of the oxygen sensor 21 is not more than a specified value (for example, a value corresponding to an atmospheric state) in a state in which the constant current flowing between the sensor electrodes is set to 0 mA. When it is determined that the output of the oxygen sensor 21 is not more than the specified value, it is determined that the abnormality-diagnosis-performance condition is met and the abnormality-diagnosis-permission flag is set on (in the permitted state).

In the abnormality-diagnosis-permission determination routine shown in FIG. 17, first, in step 801, it is determined whether the sensor element 31 is in an active state. When it is determined that the sensor element 31 is in the active state, the routine proceeds to step 802 in which it is determined whether the output of the oxygen sensor 21 is not more than a specified value. The specified value is set at a value (for example, a value not more than 0.05 V) corresponding to an atmospheric state (lean state).

When it is determined that the output of the oxygen sensor 21 is not more than the specified value in this step 802, the routine proceeds to step 803 in which the constant current circuit 27 is controlled in such a way as to set the constant current, which flows between the sensor electrodes, to 0 mA. Then, the routine proceeds to step 804 in which it is again determined whether the output of the oxygen sensor 21 is not more than the specified value. This is because of the following reason. When the constant current flows between the sensor electrodes, the output of the oxygen sensor 21 becomes smaller than the output of the oxygen sensor 21 in a state where the constant current is set to 0 mA. Hence, it is determined again whether the output of the oxygen sensor 21 is not more than the specified value in the state where the constant current is set to 0 mA. It can be determined whether the output of the oxygen sensor 21 is not more than the specified value with high accuracy without suffering the effect of the constant current. Thus, robustness can be improved.

When it is determined that the output of the oxygen sensor 21 is not more than the specified value in this step 804, it is determined that the output of the oxygen sensor 21 is in the stable lean state and that the abnormality-diagnosis-performance condition is met. Then, the routine proceeds to step 805 in which the abnormality-diagnosis-permission flag is set on (in the permitted state).

On the other hand, when determination result in any one of the steps 801, 802, 804 is “NO”, it is determined that the abnormality-diagnosis-performance condition is not met. Then, the routine proceeds to step 806 in which the abnormality-diagnosis-permission flag is held set off (in the prohibited state) or reset.

In the present embodiment 4 described above, when it is determined that the output of the oxygen sensor 21 is not more than the specified value in the state where the constant current flowing between the sensor electrodes is made 0 mA, it is determined that the output of the oxygen sensor 21 is in the stable lean state and that the abnormality-diagnosis-permission condition is met. Hence, when the output of the oxygen sensor 21 is brought into the stable lean state, the abnormality diagnosis can be performed by switching the value of the current flowing between the sensor electrodes and hence the accuracy of the abnormality diagnosis can be improved. Further, a signal relating to an engine control (for example, a fuel cutting flag or the like) does not need to be used and hence there is presented also an advantage that the abnormality diagnosis can be finished by the microcomputer 26 for controlling the oxygen sensor.

### Embodiment 5

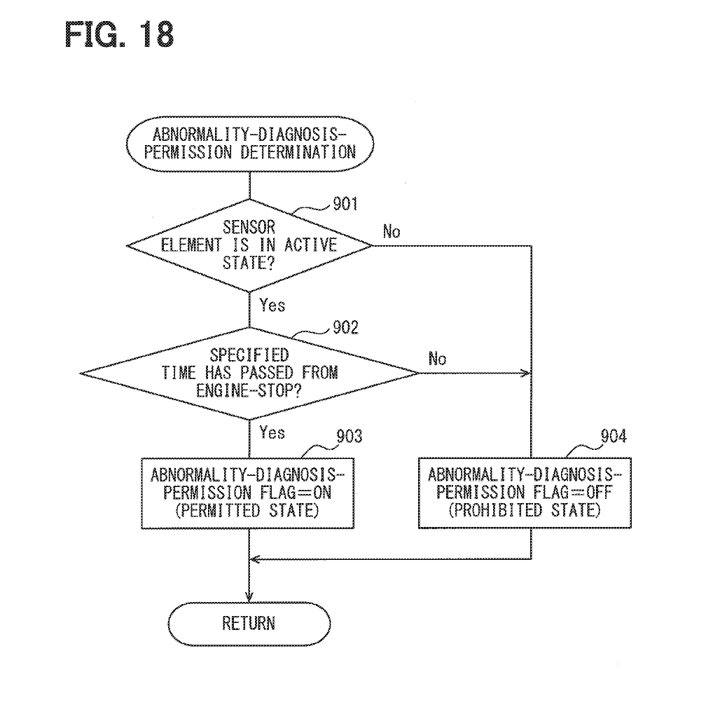

Next, an embodiment 5 of the present invention will be described by the use of FIG. 18. However, the descriptions of the parts substantially identical to those in the embodiment 3 will be omitted or simplified and parts different from those in the embodiment 3 will be mainly described.

In the present embodiment 5, the ECU 25 (or the microcomputer 26) performs an abnormality-diagnosis-permission determination routine shown in FIG. 18, which will be described later, thereby determining whether the abnormality-diagnosis-performance condition is met based on whether a specified time has passed after the engine is stopped. When it is determined that the specified time has passed after the engine is stopped, it is determined that the abnormality-diagnosis-performance condition is met and the abnormality-diagnosis-permission flag is set on (in the permitted state).

In order to make it possible for the ECU 25 (or the microcomputer 26) to perform the abnormality-diagnosis-permission determination routine shown in FIG. 18 and the abnormality diagnosis routine shown in FIG. 16 even after the engine is stopped, a main relay (not shown in the drawing) of a power source line is held ON, whereby the electric current flow to the ECU 25 (or the microcomputer 26) is continued for a while also after an IG switch (ignition switch), which is not shown in the drawing, is turned off.

In the abnormality-diagnosis-permission determination routine shown in FIG. 18, first, in step 901, it is determined whether the sensor element 31 is in an active state. When it is determined that the sensor element 31 is in the active state, the routine proceeds to step 902 in which it is determined whether a specified time has passed from the time when the engine is stopped (for example, the IG switch is turned off). The specified time is set at a time required for the interior of the exhaust pipe 17 to be brought into a state (lean state) nearly equal to the atmosphere.

When it is determined that the specified time has passed from the time when the engine is stopped in this step 902, it is determined that the output of the oxygen sensor 21 is in a stable lean state and that the abnormality-diagnosis-performance condition is met. Then, the routine proceeds to step 903 in which the abnormality-diagnosis-permission flag is set on (in the permitted state).

On the other hand, when the determination result in any one of the steps 901, 902 is “NO”, it is determined that the abnormality-diagnosis-performance condition is not met. Then, the routine proceeds to step 904 in which the abnormality-diagnosis-permission flag is held off (in the prohibited state) or reset.

In the present embodiment 5 described above, the interior of the exhaust pipe 17 is brought into the state (lean state) nearly equal to the atmosphere after the engine is stopped. When it is determined that the specified time has passed from the time when the engine is stopped, it is determined that the output of the oxygen sensor 21 is brought into the stable lean state and that the abnormality-diagnosis-performance condition is met. Hence, when the output of the oxygen sensor 21 is brought into the stable lean state after the engine is stopped, the abnormality diagnosis can be performed by switching the value of the current flowing between the sensor electrodes and hence the accuracy of the abnormality diagnosis can be improved. Also in this case, a signal relating to an engine control (for example, a fuel cutting flag or the like) does not need to be used and hence there is presented an advantage that the abnormality diagnosis can be completed by the microcomputer 26 for controlling the oxygen sensor.

### Embodiment 6

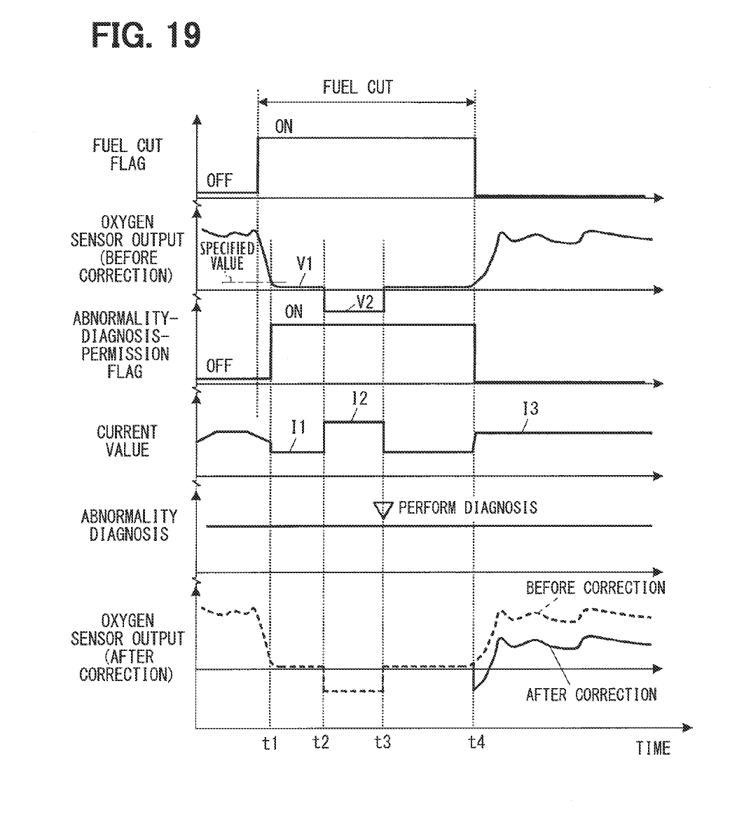

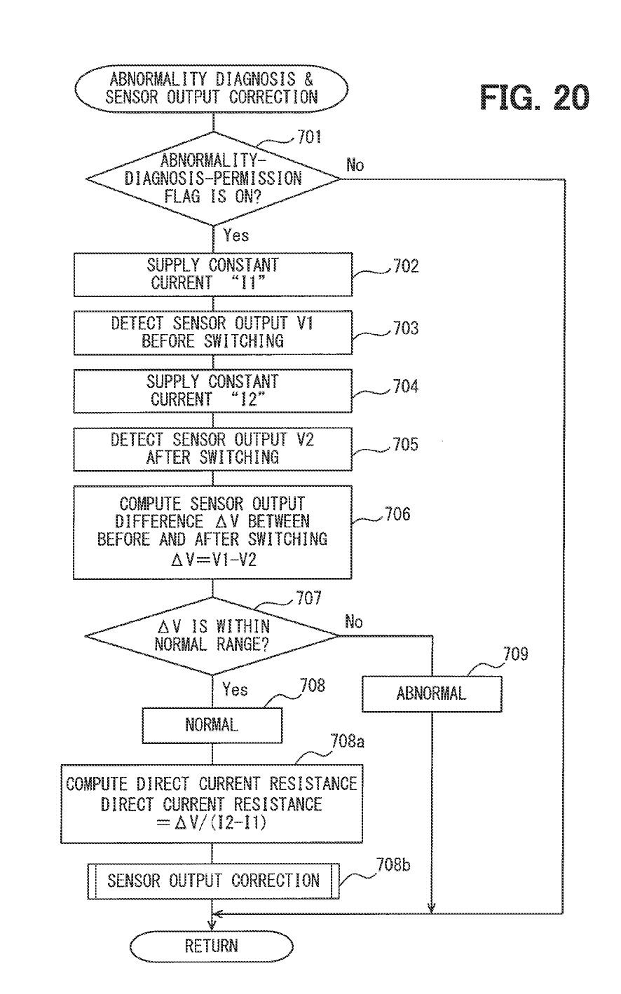

Next, an embodiment 6 of the present invention will be described by the use of FIG. 19 and FIG. 20. However, the descriptions of the parts substantially identical to those in the embodiment 3 will be omitted or simplified and parts different from those in the embodiment 3 will be mainly described.

In the present embodiment 6, the ECU 25 (or the microcomputer 26) performs a routine shown in FIG. 20, which will be described later, thereby performing the abnormality diagnosis of the constant current circuit 27 and the correction of the output of the oxygen sensor 21 in the following manner.

As shown by a time chart in FIG. 19, when the abnormality-diagnosis-performance condition is met in the fuel cutting period and the abnormality-diagnosis-permission flag is set on (in the permitted state), the value of the current flowing between the sensor electrodes is switched from “I1” to “I2” and the abnormality diagnosis of the constant current circuit 27 is performed on the basis of a difference ΔV (=V1−V2) in the output of the oxygen sensor 21 between before and after the switching.

At this time, in a period from a timing t1 to a timing t2, the output of the oxygen sensor 21 of when the constant current “I1” is made to flow between the sensor electrodes is sensed as a sensor output V1 before the switching. Then, in a period from the timing t2 to a timing t3, the output of the oxygen sensor 21 of when the constant current “I2” is made to flow between the sensor electrodes is sensed as a sensor output V2 after the switching. Then, an abnormality diagnosis for determining whether an abnormality is caused in the constant current circuit 27 is performed based on whether a difference ΔV in the sensor output between before and after the switching is within a specified normal range.

As a result, when it is determined that the constant current circuit 27 is not abnormal (is normal), the direct current resistance value (internal resistance value) of the oxygen sensor 21 is computed on the basis of the difference ΔV in the sensor output between before and after the switching. Then, at a timing t4 when the fuel cutting is finished and the abnormality-diagnosis-permission flag is set off or reset, a constant current “I3” is made to flow between the sensor electrodes to thereby change the output characteristics of the oxygen sensor 21. Then, during a period in which the constant current is being supplied (in other words, in a period in which the output characteristics of the oxygen sensor 21 are being changed), an amount of output-voltage-variation (an amount of output voltage drop or an amount of output voltage rise) is obtained from the constant current “I3” and the direct current resistance value. Then the output of the oxygen sensor 21 is corrected by the use of the amount of output-voltage-variation.

On the other hand, when it is determined that the constant current circuit 27 is abnormal, the correction of the output of the oxygen sensor 21 is prohibited. In this way, it is possible to prevent the output of the oxygen sensor 21 from being corrected on the basis of the difference ΔV in the sensor output, which is made outside of the normal range due to the abnormality of the constant current circuit 27.

A routine shown in FIG. 20, which is performed in the present embodiment 6, is a routine in which processing of steps 708a, 708b are added following the processing of the step 708 shown in FIG. 16, which has been described in the embodiment 3, and the processing of the respective steps other than those steps are the same as the processing shown in FIG. 16.

In a routine for performing an abnormality diagnosis and for correcting a sensor output correction, which is shown in FIG. 20, when it is determined that the abnormality-diagnosis-permission flag is on (in the permitted state), the constant current circuit 27 is controlled in such a way as to make the constant current “I1” flow between the sensor electrodes. The output of the oxygen sensor 21 of when the constant current “I1” is made to flow between the sensor electrodes is sensed as the sensor output V1 before the switching. Then the constant current circuit 27 is controlled in such a way as to make the constant current “I2” flow between the sensor electrodes. The output of the oxygen sensor 21 of when the constant current “I2” is made to flow between the sensor electrodes is sensed as the sensor output V2 after the switching (steps 701 to 705).

Thereafter, the sensor output difference ΔV (=V1−V2) between before and after the switching is computed and it is determined whether the sensor output difference ΔV between before and after the switching is within the specified normal range (steps 706, 707).

When it is determined in the step 707 that the sensor output difference ΔV between before and after the switching is within the specified normal range, the routine proceeds to step 708 in which it is determined that the constant current circuit 27 is not abnormal (is normal). Then, the routine proceeds to step 708a in which the direct current resistance value (internal resistance value) of the oxygen sensor 21 is computed from the sensor output difference ΔV between before and after the switching and a difference (I2−I1) in the current value between before and after the switching.

Direct current resistance value=ΔV/(I2−I1)

Thereafter, the routine proceeds to step 708b in which the sensor output correction routine shown in FIG. 11, which has been described above, is performed. In this way, during the period in which the constant current is being supplied (in other words, during the period in which the output characteristics of the oxygen sensor 21 are being changed), the amount of output-voltage-variation (the amount of output voltage drop or the amount of output voltage rise) caused due to the internal resistance of the oxygen sensor 21 at the time of the constant current supply is obtained by use of the constant current value and the direct current resistance value (the internal resistance value) of the oxygen sensor 21. Then, the sensor output (output of the oxygen sensor 21) is corrected by the use of the amount of output-voltage-variation.

On the other hand, when it is determined in the step 707 that the sensor output difference ΔV between before and after the switching is not within the specified normal range (in other words, outside the normal range), the routine proceeds to step 709 in which it is determined that the constant current circuit 27 is abnormal (for example, is failed). Then, the present routine is finished without performing the processing of the steps 708a, 708b to thereby prohibit the output of the oxygen sensor 21 from being corrected. This function plays a role as a prohibition portion.

In the embodiment 3 described above, it is determined whether an abnormality is caused in the constant current circuit 27 based on whether the difference ΔV in the output of the oxygen sensor 21 between before and after switching the value of the current flowing between the sensor electrodes is within the normal range. When it is determined that an abnormality is caused in the constant current circuit 27, the correction of the output of the oxygen sensor 21 is prohibited. Hence, it is possible to previously prevent the output of the oxygen sensor 21 from being corrected on the basis of the sensor output difference ΔV (abnormal value) which is made out of the normal range by the abnormality caused in the constant current circuit 27.

In this regard, in the present embodiment 6 described above, the sensor output correction routine shown in FIG. 11 is performed in the step 708b of the routine shown in FIG. 20. However, the correction routine is not limited to this but the target voltage correction routine shown in FIG. 12 may be performed in the step 708b.

In other words, when it is determined in the step 707 that the sensor output difference ΔV between before and after the switching is within the normal range, the routine proceeds to step 708 in which it is determined that the constant current circuit 27 is not abnormal (is normal). Then, the routine proceeds to step 708a in which the direct current resistance value (Internal resistance value) of the oxygen sensor 21 is computed from the sensor output difference ΔV between before and after the switching. Thereafter, the routine proceeds to step 708b in which the target voltage correction routine shown in FIG. 12, which has been described above, is performed. In this way, during the period in which the constant current is being supplied (in other words, during the period in which the output characteristics of the oxygen sensor 21 are being changed), the amount of output-voltage-variation (the amount of output voltage drop or the amount of output voltage rise) caused due to the internal resistance of the oxygen sensor 21 at the time of the constant current supply is obtained by the use of the constant current value and the direct current resistance value (internal resistance value) of the oxygen sensor 21. Then, the target voltage of the subordinate F/B control is corrected by the use of the amount of output-voltage-variation.

In contrast to this, when it is determined in the step 707 that the sensor output difference ΔV between before and after the switching is not within the normal range (that is, outside the normal range), the routine proceeds to step 709 in which it is determined that the constant current circuit 27 is abnormal (for example, is failed). Then, the present routine is finished without performing the processing of the steps 708a and 708b, whereby the correction of the target voltage of the subordinate F/B control is prohibited. In this way, it is possible to prevent the target voltage of the subordinate F/B control from being corrected on the basis of the sensor output difference ΔV (abnormal value), which is made out of the normal range by the abnormality of the constant current circuit 27.

In the respective examples 3 to 6 described above, it is determined whether the abnormality is caused in the constant current circuit 27 based on whether the sensor output difference ΔV between before and after the switching (difference between the sensor output V1 before the switching and the sensor output V2 after the switching) is within the specified normal range. However, the method for determining whether an abnormality is caused in the constant current circuit 27 is not limited to this, but may be changed as required. For example, it may be determined whether an abnormality is caused in the constant current circuit 27 based on whether the ratio of the sensor outputs before and after the switching (the ratio of the sensor output V1 before the switching to the sensor output V2 after the switching) is within a specified normal range.

In the respective examples 1 to 6 described above, when the value of the current flowing between the sensor electrodes is switched, the constant current before the switching is set at 0 mA. However, the constant current before the switching is not limited to this but may be set at a specified value other than 0 mA. In this case, the constant current “I2” after the switching may be set at 0 mA or may be set at a specified value other than 0 mA.

In the respective examples 1 to 6 described above, it is determined that when the output of the oxygen sensor 21 is stable lean state, the current-switching-permission condition (or abnormality-diagnosis-performance condition) is met. However, the condition for determining whether the current-switching-permission condition is met is not limited to this, but it may be determined that when the output of the oxygen sensor 21 is stable rich state, the current-switching-permission condition (or abnormality-diagnosis-performance condition) is met. For example, it may be determined that the current-switching-permission condition (or abnormality-diagnosis-performance condition) is met during a fuel-quantity-increase control in which a fuel injection quantity of the engine 11 is increased. During the fuel-quantity-increase control, a rich gas flows in the exhaust pipe 17 and hence the interior of the exhaust pipe 17 is brought into a rich state. Hence, if it is determined during the fuel-quantity-increase control that the current-switching-permission condition (or abnormality-diagnosis-performance condition) is met, when the output of the oxygen sensor 21 is brought into a stable rich state during the fuel-quantity-increase control, the value of the current flowing between the sensor electrodes can be switched to thereby compute the output-voltage-variation information.

In the respective examples 1 to 6 described above, when the specified current-switching-permission condition (or abnormality-diagnosis-performance condition) is met, the value of the current flowing between the sensor electrodes is switched to thereby compute the output-voltage-variation information (or the output-voltage-variation information is computed to thereby perform the abnormality diagnosis). However, the condition for operating the output-voltage-variation information is not limited to this but, for example, when the value of the current flowing between the sensor electrodes is switched according to a change request for improving the rich responsiveness of the oxygen sensor 21 or a change request for improving the lean responsiveness of the oxygen sensor 21, the output-voltage-variation information may be computed (or the output-voltage-variation information may be computed to thereby perform the abnormality diagnosis).

In the respective examples 1 to 6 described above, the constant current circuit 27 is connected to the atmosphere electrode layer 34 of the oxygen sensor 21 (sensor element 31). However, the configuration of the engine control system is not limited to this configuration. For example, the constant current circuit 27 may be connected to the exhaust electrode layer 33 of the oxygen sensor 21 (sensor element 31). Alternatively, the constant current circuit 27 may be connected to both of the exhaust electrode layer 33 and the atmosphere electrode layer 34.

In the respective examples 1 to 6 described above, the present invention has been applied to a system using the oxygen sensor 21 having the sensor element 31 of a cup type structure. However, a system to which the present invention is applied is not limited to this, but the present invention may be applied to a system using an oxygen sensor having a sensor element of a laminated structure type.

Further, the present invention may be applied not only to the oxygen sensor but also to a gas sensor other than the oxygen sensor, for example, an air-fuel ratio sensor for outputting a linear air-fuel ratio signal according to an air-fuel ratio, an HC sensor for sensing an HC concentration, or a NOx sensor for sensing a NOx concentration. Still further, the present invention may be applied to a gas sensor used for an object other than the engine.

1. A gas-sensor-control device having a gas sensor including a sensor element for sensing a concentration of a specified component contained in a gas, the sensor element having a solid electrolyte material arranged between a pair of sensor electrodes, the gas-sensor-control device comprising:
a constant current supply portion making a constant current flow between the sensor electrodes so as to change an output characteristic of the gas sensor; and
an output-voltage-variation information computing portion computing an amount of output-voltage-variation of the gas sensor or an information correlating to the amount of output-voltage-variation (which is hereinafter generally referred to as “output-voltage-variation information”) at a time of a constant current supply in which the constant current flows between the sensor electrodes based on outputs of the gas sensor before and after switching a value of a current flowing between the sensor electrodes.

2. The gas-sensor-control device as claimed in claim 1, further comprising:
a determination portion determining whether a specified current-switching-permission condition is met, wherein
when the output-voltage-variation information computing portion determines that the specified current-switching-permission condition is met, the output-voltage-variation information computing portion switches the value of the current flowing between the sensor electrodes so as to compute the output-voltage-variation information.

3. The gas-sensor-control device as claimed in claim 2, wherein
the gas sensor is a sensor for sensing whether an air-fuel ratio of an emission gas of an internal combustion engine is rich or lean.

4. The gas-sensor-control device as claimed in claim 3, wherein
when an output of the gas sensor is stable rich state or stable lean state, the determination portion determines that the specified current-switching-permission condition is met.

5. The gas-sensor-control device as claimed in claim 4, wherein
the determination portion determines that the specified current-switching-permission condition is met during a fuel cutting period in which a fuel injection of the internal combustion engine is stopped.

6. The gas-sensor-control device as claimed in claim 4, wherein
the determination portion determines that the specified current-switching-permission condition is met after the internal combustion engine is stopped.

7. The gas-sensor-control device as claimed in claim 4, wherein
the determination portion determines that the specified current-switching-permission condition is met during a fuel-quantity-increase control in which a fuel injection quantity of the internal combustion engine is increased.

8. The gas-sensor-control device as claimed in claim 1, wherein
when the value of the current flowing between the sensor electrodes is switched, the output-voltage-variation information computing portion sets one of the values of the current before and after switching to zero.

9. The gas-sensor-control device as claimed in claim 1, further comprising:
an abnormality diagnosis portion performing an abnormality diagnosis for determining whether an abnormality is caused in the current supply portion based on the output-voltage-variation information.

10. A control device of an internal combustion engine having the gas-sensor-control device as claimed in claim 1 and a control portion performing a control of an internal combustion engine based on the outputs of the gas sensor, the control device of an internal combustion engine comprising:
a sensor-output-correction portion for correcting the outputs of the gas sensor based on the output-voltage-variation information at the time of the constant current supply, wherein
the control portion performs the control by using of the output of the gas sensor corrected by the sensor-output-correction portion.

11. The control device of an internal combustion engine as claimed in claim 10, wherein
the output-voltage-variation information computing portion computes a direct current resistance value of the gas sensor as the output-voltage-variation information, and
the sensor-output-correction portion obtains the amount of output-voltage-variation from the constant current value and the direct current resistance value at the time of the constant current supply and corrects an output of the gas sensor by using of the amount of output-voltage-variation.

12. The control device of an internal combustion engine as claimed in claim 10, further comprising:
an abnormality diagnosis portion determining whether an abnormality is caused in the constant current part based on the output-voltage-variation information; and
a prohibition portion prohibiting an output of the gas sensor from being corrected by the sensor-output-correction portion in a case where the abnormality diagnosis portion determines that an abnormality is caused in the constant current part.

13. A control device of an internal combustion engine having the gas-sensor-control device as claimed in claim 1 and a control portion performing an air-fuel ratio control of an internal combustion engine based on the outputs of the gas sensor, the control device of an internal combustion engine comprising:
a target-value-correction portion correcting a target value of the air-fuel ratio control based on the output-voltage-variation information at the time of the constant current supply, wherein
the control portion performs the air-fuel ratio control by using of the target value corrected by the target-value-correction portion.

14. The control device of an internal combustion engine as claimed in claim 13, wherein
the output-voltage-variation information computing portion computes a direct current resistance value of the gas sensor as the output-voltage-variation information, and
the target-value-correction portion obtains the amount of output-voltage-variation from the constant current value and the direct current resistance value at the time of the constant current supply and corrects the target value by using of the amount of output-voltage-variation.

15. The control device of an internal combustion engine as claimed in claim 13, further comprising:
an abnormality diagnosis portion determining whether an abnormality is caused in the constant current supply portion based on the output-voltage-variation information; and
a prohibition portion prohibiting the target value from being corrected by the target-value-correction portion in a case where the abnormality diagnosis portion determines that an abnormality is caused in the constant current supply portion.
